(19) United States
(12) Patent Application Publication
(10) Pub. No.: US 2007/0260532 A1
(43) Pub. Date: Nov. 8, 2007

(54) A living budget program where the term living budget refers to a new interface and methodology for managing finances

(76) Inventor: Charles Anthony Blake III, Palmdale, CA (US)

Correspondence Address: CHARLES A. BLAKE III, 3034 MARICOTTE DRIVE, PALMDALE, CA, 93550, US

(21) Appl. No.: 11/381,455

(22) Filed: May 3, 2006

(51) Int. Cl. G06Q 40/00

(52) U.S. Cl. 705/35

(57) ABSTRACT

Disclosed is a financial management software application that provides a means of creating and managing living budgets. A Living Budget is the evolving statement of financial position laid out in terms where one can easily manipulate its various components (210) (211) (216) and see results the across all periods within its scope (208) (205), which is typically a year; differs from a budget in that proposed solutions are easily discernible by virtue of the layout. The enhanced visibility, ease of edit, and layout provide a new and improved method for managing finances. The end result is that consumers will not only have the ability to reconcile their accounts, but can easily create many what-if scenarios and instantly see how those changes effect their financial situation. This application will help those who are in immediate financial distress, or those who just want to improve their financial situation.

### CROSS-REFERENCE TO RELATED APPLICATIONS

Not Applicable

### FEDERALLY SPONSORED RESEARCH

Not Applicable

### SEQUENCE LISTING OR PROGRAM

Attached is a CD with the source code for this invention. The ASCII program listing is presented in Microsoft Intermediate Language built using Microsoft Visual Studio 2005. Additionally, FlexCell.dll and DevComponents.DotNetBar2.dll are required by the program and can be obtained through their manufactures. FlexCell.dll is a component supplied by FlexCell Technologies at www.grid2000.com. DevComponents.DotNetBar2.dll is a component supplied by DevComponents.com at www.DevComponents.com.

### BACKGROUND OF THE INVENTION

1. Field of Invention

This invention generally relates to budgets, specifically to a new method of displaying and interacting with budgeting data.

2. Prior Art

Business Accounting, Personal Finance, and Budget Programs all offer the option of setting up a budget. Users enter budgetary limits for the account/category and these applications utilize that information to produce various reports which among other things alerts the user to that account/category's current standing relative to the initial budget. In most instances the budget is an ancillary feature of the main program and is produced in the form of non-interactive reports. Where the reports or display is interactive, the budget is not the main focal point of the program. Those programs that are budget oriented either rely on the actual verses budget standard or do not provide the field visibility as described in this invention.

The problem is that the consumer does not have a program that provides proper visibility to their finances in a way that they can see the “Big Picture” or the net results of their actions. A checkbook balance does not provide enough context by itself to answer the question, “is there really enough in the checkbook to support the purchase of that item?” Although viewing reports, charts and graphs are helpful in spotting trends they lack the view and interaction required to help the consumer change and manage their spending patterns.

### SUMMARY

In accordance with the present invention a new type of budgeting program that effectively provides a means for the user to see the value of their dollars. This invention demonstrates a new way of looking at and managing a budget which is not necessarily bound to traditional budgetary goal limits. More specifically, this program does not require the use of actual verses budget, although it does not preclude its use. The goal is to provide a workspace where the user can enter actual data and instantly see the net effects of that action within the context of their finances. Beyond just listing income, expenses, accruals, etc. . . . , all fields are now editable. The end result is that users not only have the ability to reconcile their accounts, but can instantly create many what-if scenarios and observe the changes to their financial situation.

### DRAWINGS—FIGURES

FIGS. 1, 31, 32 are showing the main workspace with different tabs selected to provide visibility to some of the features of the product.

FIGS. 2-6 show the contents of the main menu.

FIG. 7 shows totals with emphasis on the source columns.

FIG. 8 shows the pay-period entries that are associated with specific payees.

FIGS. 9-37 are various forms related to the new budget wizard which is used to create budgets.

FIG. 9 is the New Budget Wizard welcome page.

FIG. 10 is Step 2 of the new budget wizard where a name is given to the budget.

FIG. 11 is Step 3 of the new budget wizard which is prompting the user to select the year for which this budget will be created.

FIG. 12, Step 4 of the new budget wizard is asking the user if they want to use an override. Override Pay provides a means to create a budget based on user selected periods that are not tied to the user's primary income source. This is useful where the user gets paid on irregular intervals but needs to pay bills in a more regular fashion.

FIGS. 13-17 show the effects of selecting the different radio buttons on the Override Pay form.

FIG. 18 is Step 5 of the new budget wizard, and is where the initial amount is entered. The initial amount or balance is added to the budget and is helpful in ensuring the budget reconciles to the main account.

FIG. 19 is Step 6 of the new budget wizard, and is where the program enters an area where the actual budget information is entered.

FIG. 20 is the Load Initial Payees form. One-by-one payees are added to the budget with dollar totals being displayed on the form.

FIG. 21 is the Payee Load form where all the details of a payee are entered.

FIG. 22 is a is a matrix of the possible pay-periods and the corresponding data that can be entered into the Pay Date and Optional additional Pay Date text boxes in FIG. 21.

FIG. 23 is the Category Selection form where new categories are created and selected for use.

FIG. 24 shows the Category Entry form where new categories are created.

FIGS. 25-27 show the various category forms a multi-level (parent-child) category structure is created.

FIG. 28 shows the Payee Load form with a Compute end date payee entered. The Compute end date radio is set on yes, and a target amount has been entered. The target amount represents the current loan amount on the loan.

FIGS. 29-33 show the various category forms a multi-level (parent-child) category structure is created.

FIG. 34 shows the Payee Load form with a Tithe payee entered. Since a tithe is 10% of the income for a given period, the amount field is grayed and unavailable.

FIG. 35 shows the Payee Load form with an Accrual payee entered. Notice that the Accrual and Compute end date radios are set to yes. The target amount is the amount of money the user wants to accrue. The program will stop creating transactions once the target amount is met.

FIG. 36 is the Load Initial Payees form with the fields updated.

FIG. 37 is Step 7 of the new budget wizard, and is where the program provides a last chance to quit before creating the new budget.

FIG. 39 is displaying a small sample budget. What should be noted is that the budget was created in March and that the program only creates budgets from the current month through the end of the current year. Notice how the first tab is March.

FIGS. 40-42 show the different ways transactions are modified.

FIGS. 43-44 show the Insert Transaction form, initially, and completed.

FIG. 45 is the Payee Entry form. This is the main form used in creating recurring payees.

FIG. 46 is the Quick Transaction form. This form is used to create payees with one-time transactions.

FIG. 47 is showing the newly created ‘Home Maintenance’ payee placed alphabetically in the Transactions Descriptions column.

FIG. 48 shows the Insert Transaction form, specifically locating a payee in a month where they are not listed so a new transaction can be created.

FIGS. 49-52 show how accruals are manipulated within the application and its effects.

FIG. 53 is displaying the options the context menu has when the cursor is hovering in the ‘Transactions Descriptions’ column.

FIG. 54 is the Payee Edit form and it is showing the fields that are available for edit after a payee is created.

FIG. 55 is the Edit Activity form.

FIG. 56 is the Category Maintenance form which is used to create, rename, or make inactive a category.

FIG. 57 is the Category Edit form which is called from the Category Maintenance form to rename or change the activity of a category.

FIG. 58 is the Category Entry form which is called from the Category Maintenance form to create categories.

FIGS. 59-63 are screenshots of the Report Selection form. The program provides the user with the ability to create several types of reports with a variety of options. FIG. 39 is a screenshot of the form which has four tabs representing four reporting groups. The principle difference between the groups is the selection criteria which are; Income/All Expenses, Income and 1 Expense, Selected Expenses, and Selected Income. All report groups allow the selection of a reporting period which could be Monthly, Quarterly, and Yearly. Additionally, Report Groups 2-4 allow the selection of categories and chart styles which provide enhanced report detail with flexible chart output options.

FIGS. 64-69 show the various output reports created through the Reports Selection form.

FIGS. 70-72 are screenshots of the Next Year Budget Wizard. Since each year's budget is fundamentally different in that the periods are unique, I created the Next Year Budget Wizard. This wizard easily and quickly creates a new budget based on the data from the current year.

FIG. 74 is displaying the newly created 2007 budget created by the ‘Next Year's Budget Wizard’ based on the current year.

FIGS. 75-76 show the context menu activated above a Tithe transaction. FIG. 75 shows an open lock and FIG. 76 shows a closed lock.

FIG. 77 is displaying the Edit Tithe Lock form. This form is used to change the status of lock.

FIGS. 78-79 show how the scrollbars are used in the main workspace. Vertical scrolling is accomplished by freezing the row above the first expense row. Freezing or locking that row keeps the income area visible at all times which provides greater usability. Horizontal scrolling is handled by scroll bars on the month grid as well as inserting scroll arrows on the tab line to provide access to hidden tabs.

FIGS. 80-83 show the various information displayed in the status bar. Since the data in very cell is a transaction, the status bar is able display detailed information describing the transaction. The status bar not only lets the user know which row the cursor is hovering above, but also displays the period. This is very helpful in selecting cells to create a transaction. Additionally, the status indicator will display the balance of accruals, and compute end date payees.

FIG. 84 is displaying the visual effects of a cell that has a negative current balance. Again, this visibility is extremely helpful to the user with regards to managing their financial situation. The user can easily see if a what-it scenario fits into their budget.

FIG. 85 is displaying a future embodiment of this invention where payees, categories, and transactions are updated from an external checkbook application. Tying these two applications together will greatly ease the management and update of the living budget by removing the need for duplicated entry.

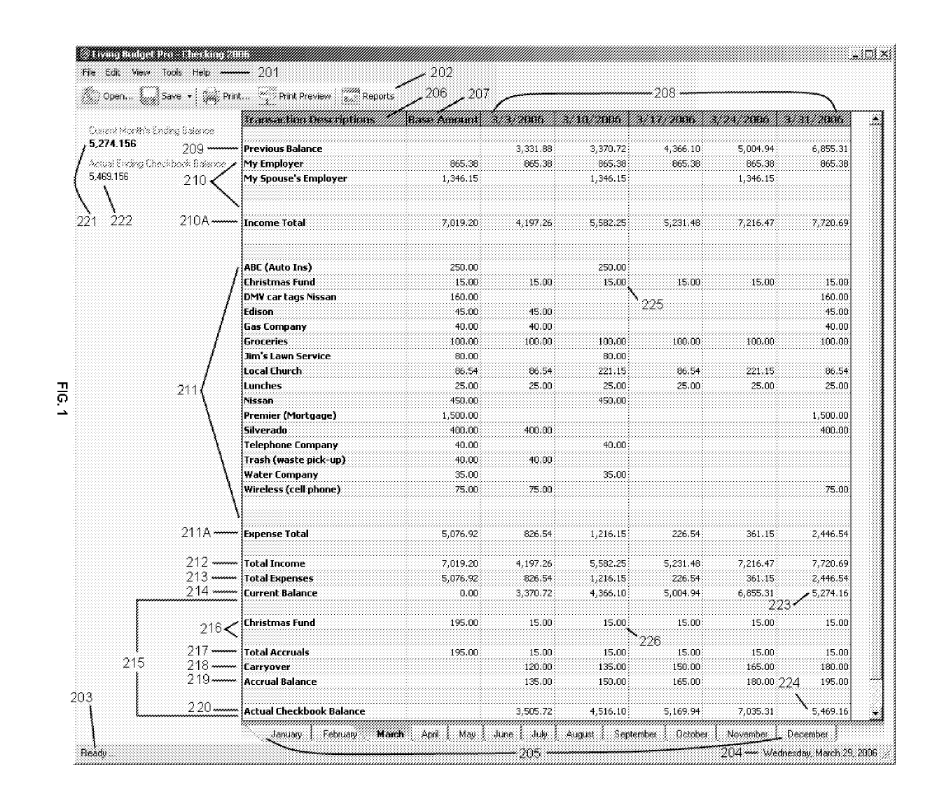

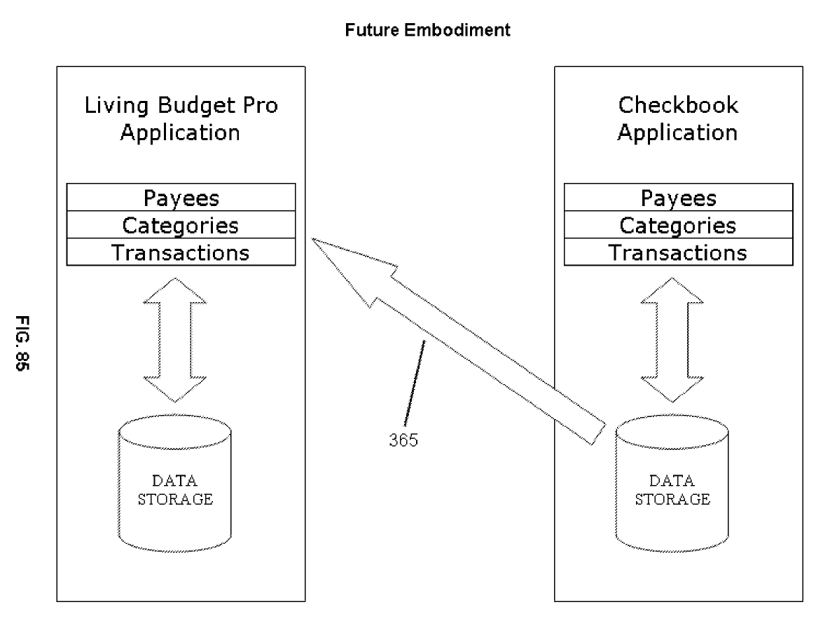

### DETAILED DESCRIPTION—PREFERRED EMBODIMENT—FIGS. 1-84

Referring to the drawings and in particular to FIG. 1, which is a screenshot of one embodiment of the current invention. FIG. 1 shows an entire month's financial activities in an easily viewed and editable form. The application has a main menu 201 which provides a means of managing the application and environment. A toolbar 202 provides a quick way to run common tasks. The status indicator 203 provides system activity information and transaction details. The system date and time 204 are displayed in right corner of the status bar. Tabs 205 located along the bottom of the workspace provide easy access to all the months included in the budget. Each month contains a spreadsheet like grid that contains the data. The first column 206 holds the descriptions of the payees. The initial base amount of every payee is located in Base Amount 207 column. The transaction periods 208 have a variable amount of columns based on the income or expense requirements of the user. The Previous Balance row 209 is a carryover row from the previous period's current balance, or in the case of the first period of the budget, the Previous Balance holds the initial balance used to start the budget. The income area 210 has a variable amount of rows based on the amount of income type payees. The Income Total row 210A is summation of the income rows plus the Previous Balance for a specific period. The expense area 211 also has a variable amount of rows depending on the amount of expense payees. The Expense Total row 211A is a summation of all the expense rows. The Total Income row 212 is the value of the Income Total row 210A. The Total Expenses row 213 is the value of the Expense Total row 211A. The Current Balance row 214 is the result of subtracting the Total Expenses row 213 from the Total Income row 212 and is un-editable. If accruals are present, meaning there is an accrual balance, the accrual area 215 will be populated, otherwise the accrual area would be blank. The accrual rows 216 contain a variable amount of rows based on the amount of active accruals. Accruals 225 are listed in the expense area 211, which are deducted from the active account; the same accrual 226 is then added to the accrual area 215 on its specific row 216. The Total Accruals row 217 is the summation of all accruals for a given period. The Carryover row 218 is the value of the total accruals from the previous period. The Accrual balance row 219 is the summation of the Total Accruals 217 and the Carryover 218 for a given period. The Actual Checkbook Balance 220 is the summation of the Current Balance 214 and the Accrual Balance 219. The Current Month's Ending Balance 221 comes from the last period of the Current Balance row 223 and is provided as a quick reference. The Actual Ending Checkbook Balance 222 comes from the last period of the Actual Checkbook Balance row 224 and is also provided for reference; this label and value is only visible where an accrual balance is present within the current month. The income area 210 is separated from the expense area 211 for clarity. The Income Total 210A, Expenses Total 211A, rows between Income Total 210A and the first expense, all rows below the Expenses Total rows, and the Base Amount column 207 are not editable.

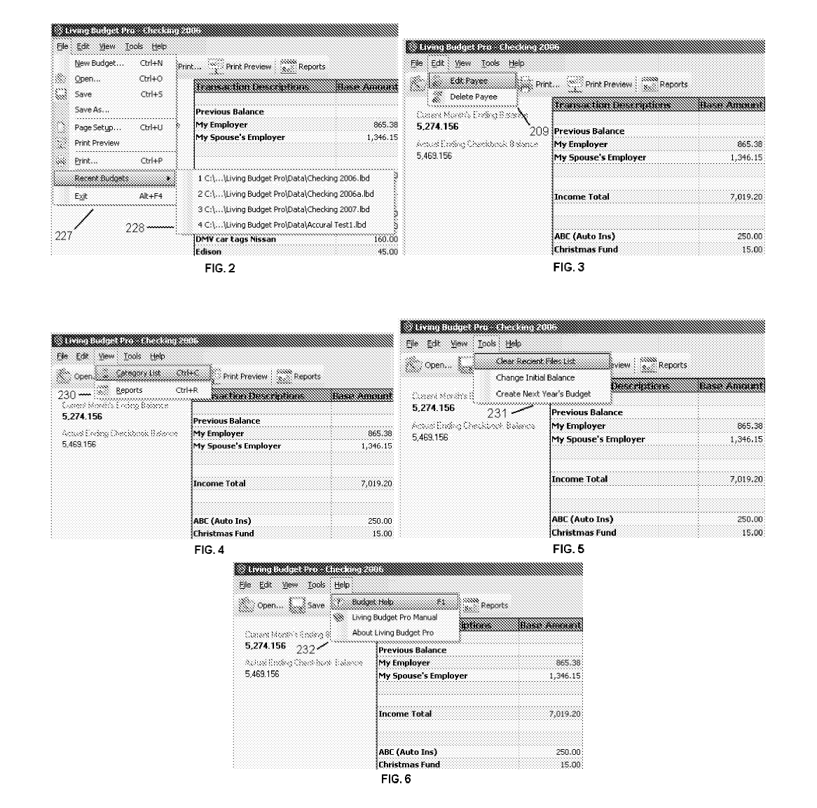

FIG. 2 is displaying the File menu 227 from the main menu bar. The File menu provides a New Budget item for creating new budgets. The File menu also provides a means for Opening, Saving, and using Saving As for budgets. Page Setup, Print Preview, and Print are also supported. The Recent Budgets drop down 228 is also supported to easily select other Budgets.

FIG. 3 is displaying the Edit menu 229 from the main menu bar. This menu provides a means for editing and deleting payees.

FIG. 4 is displaying the View menu 230 from the main menu bar. Menu items are the Category List, and Reports. Category List provides a means of listing, editing, and creating categories. The Reports menu item provides a means of creating reports for the budget.

FIG. 5 is displaying the Tools menu 231 from the main menu bar. Menu items include: Clear Recent Files List, Change Initial Balance, and Create Next Year's Budget. Clear Recent Files List will delete the list of recently viewed budgets 228 from FIG. 2. Change Initial Balance provides a means of deleting, inserting, or editing the initial balance of the budget. Create Next Year's Budget uses a wizard to create the next year's budget based on the current budget.

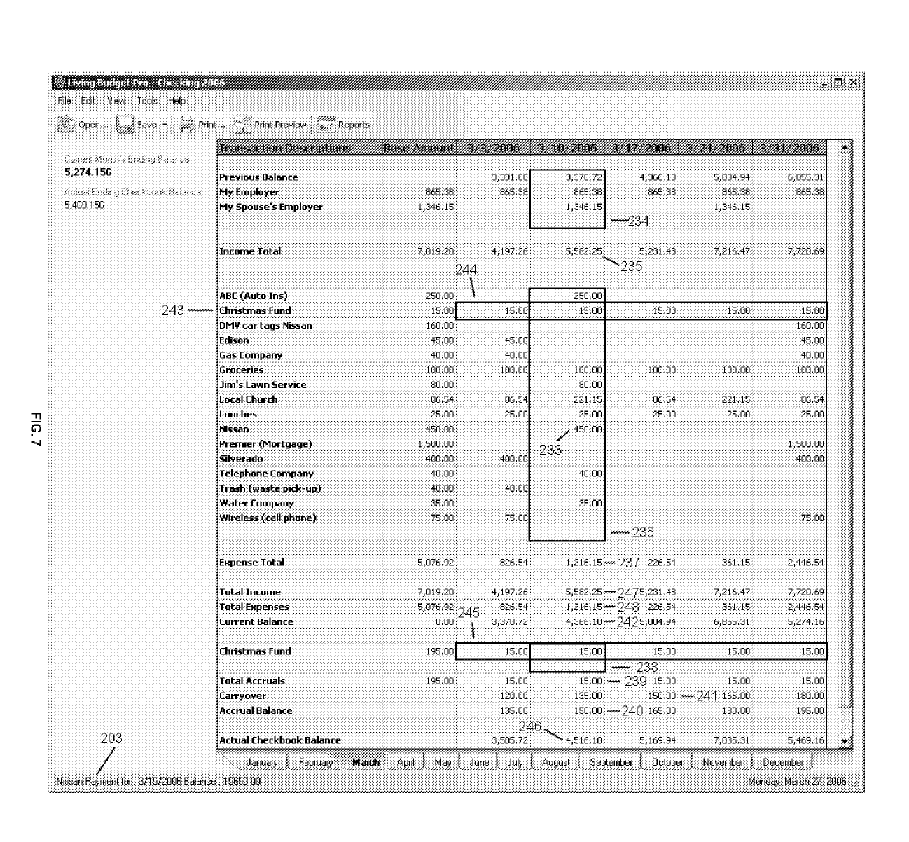

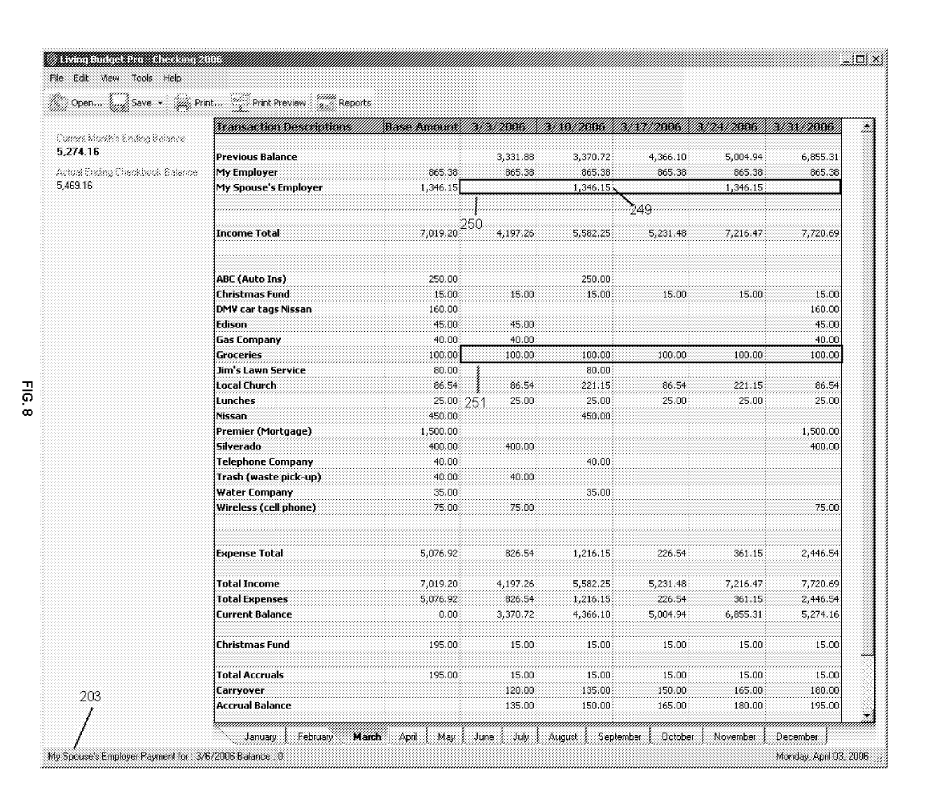

FIG. 6 is displaying the Help menu 232 from the main menu bar. Menu items are: Budget Help, Living Budget Pro Manual, and About Living Budget Pro. Budget Help evokes the help system. Living Budget Pro Manual will open the user manual. About Living Budget Pro bring up a dialog displaying information about the product.

Referring to FIG. 7, the cursor is hovering above Nissan payment in period Mar. 10, 2006, 233 and the status indicator 203 is providing additional information about the transaction; the name of the payee is shown and in this case the due date and loan balance. Income rows 234 are summed to create the Income Total 235. Expense rows 236 are summed to create the Expense Total 237. Accrual Rows 238 are summed to create the Total Accruals 239. Accruals are carried over from the Accrual Balance 240 to the Carryover row in the next period 241.

Referring to FIG. 8, the cursor is hovering above the My Spouse's Employer payment in period Mar. 10, 2006, 249 and the status indicator 203 is providing additional information about the transaction; the name of the payee, and the due date (date when the income was deposited). All transactions for a payee are listed on the same row as the payee (250 & 251) in the period columns.

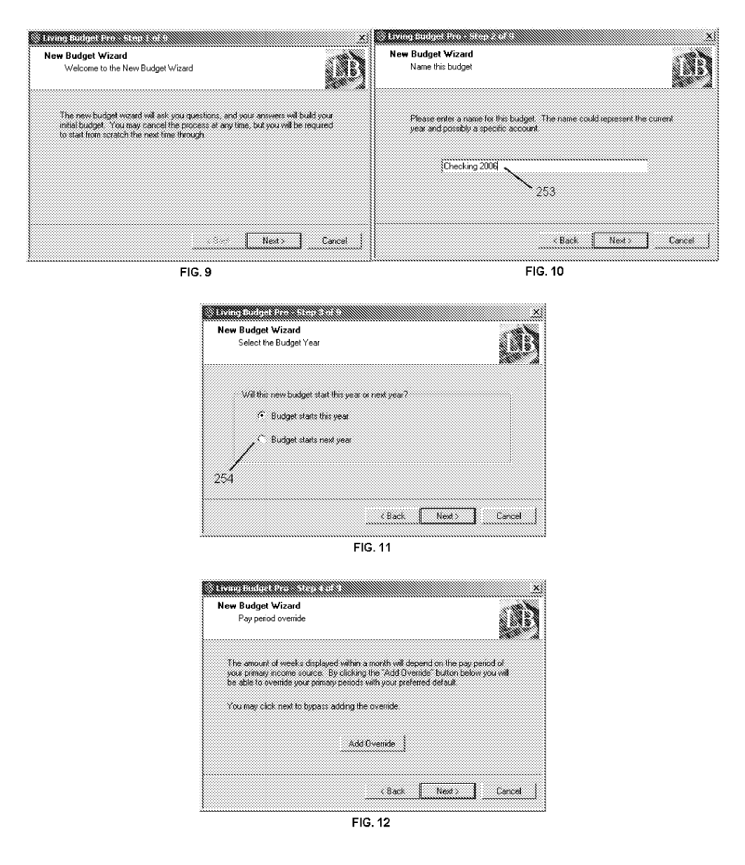

Referring to FIG. 9, the program provides a means of easily creating yearly budgets through the use of wizards. As can be seen in FIG. 10, provision was made for each budget to be uniquely named 253. Referring to FIG. 11, note it is possible to create a new budget that will start at the beginning of the next calendar year 254. This is helpful if you received this program in December and wanted to start fresh in January.

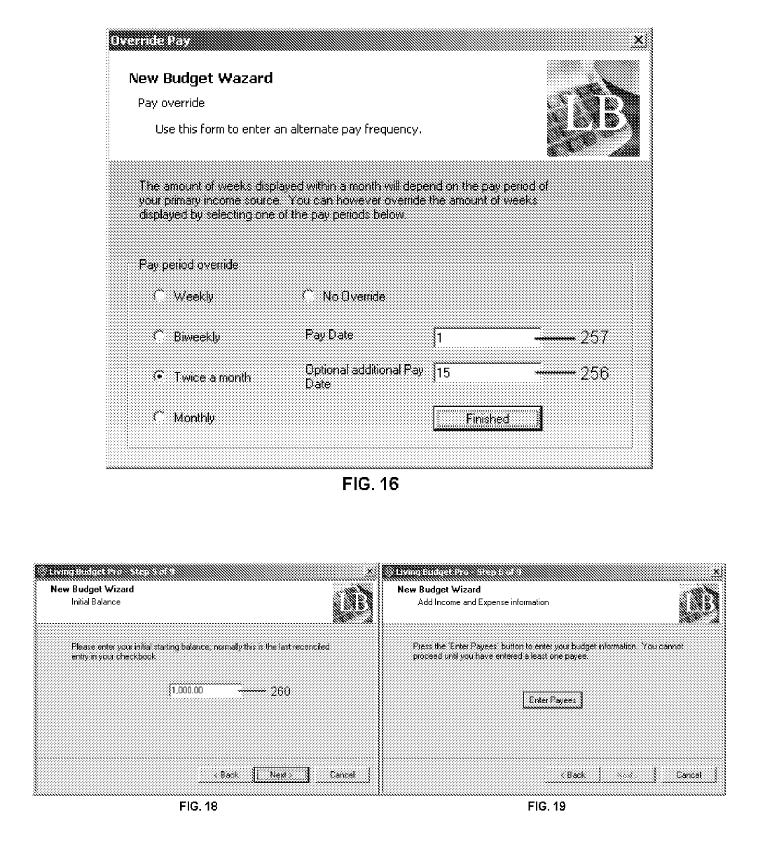

In FIG. 12, the program is providing the option to create a budget with pay-periods that are not tied to a primary income source (employer). This is particularly helpful for people who work jobs with irregular pay schedules but still need to pay their bills regularly. The Override Pay form displayed in FIG. 16 provides the option of selecting various pay-periods. FIG. 16 is a screenshot of the Override pay form with ‘Twice a month’ selected. Valid entries are numbers ranging from 1-31 in both the Pay Date 257 and Optional additional Pay Date 256 boxes.

FIG. 18 is a screenshot of Step 5 of the new budget wizard and provides a means for starting the budget with an initial balance 260. The initial amount or balance is added to the budget and is helpful in ensuring the budget reconciles to the main account. FIG. 19, Step 6 of the new budget wizard provides access to a series of forms where all the budgetary information is entered.

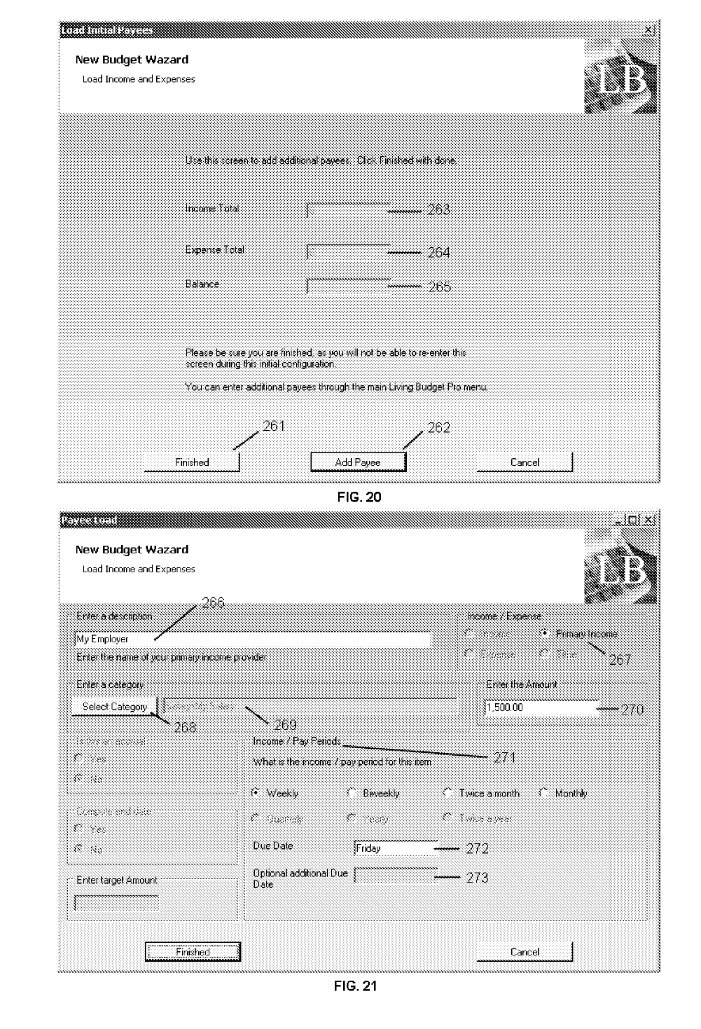

FIG. 20 is a screenshot of the Load Initial Payees form. This form provides a means of adding Payees via the ‘Add Payee’ button 262. When the user is finished entering payees, the ‘Finished’ button 261 will move the user to the next step in the budget creation process. The ‘Income Total’ box 263 tallies all the income for income type payees. The ‘Expense Total’ box 264 tallies all the expenses for expense type payees, and the ‘Balance’ box 265 represents the value of the ‘Expense Total’ subtracted from the ‘Income Total’.

Referring to FIG. 21, which is a screenshot of the Payee Load form; notice the Primary Income radio 267 is selected. The Primary Income radio is always selected on the first payee added unless the override pay option was selected. The name of the payee is entered into the description text box 266. The amount text box 270 holds the amount that this payee will receive. The ‘Select Category’ button 268 invokes the Category Selection form where you can create categories in a graphical hierarchical structure and environment; and once finished that information is placed in the category text box 269.

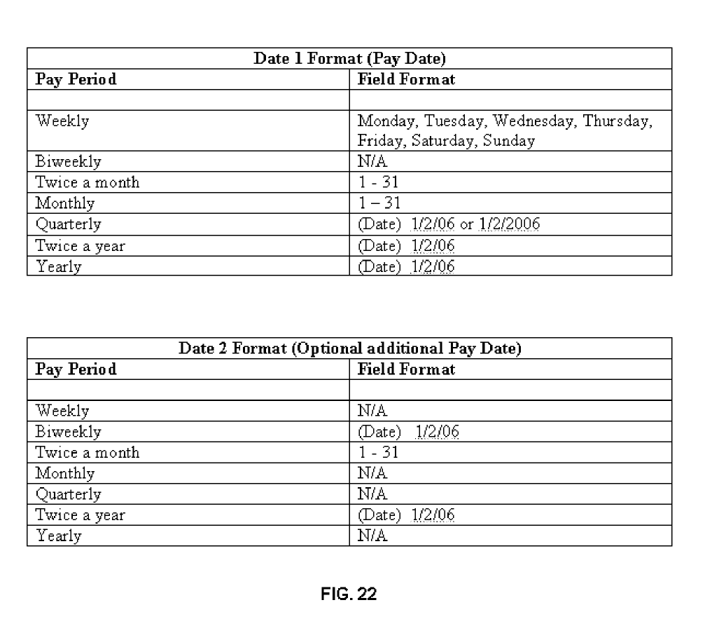

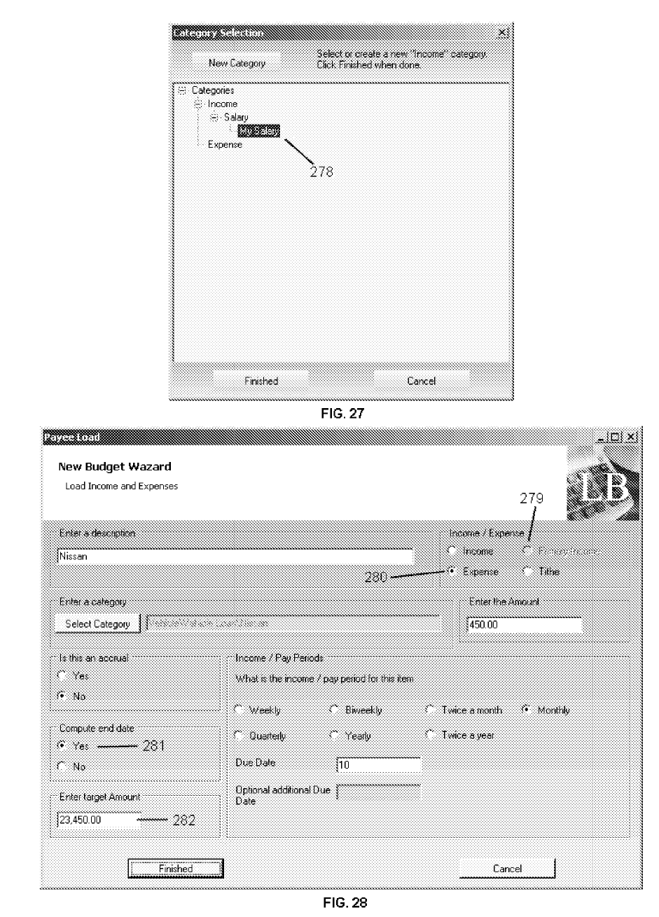

FIG. 27 is a screenshot of the Category Selection form with the desired category 278 selected. FIG. 22 is a matrix of the possible pay-periods and the corresponding data that can be entered into the Pay Date 272 and Optional additional Pay Date 273 text boxes in FIG. 21.

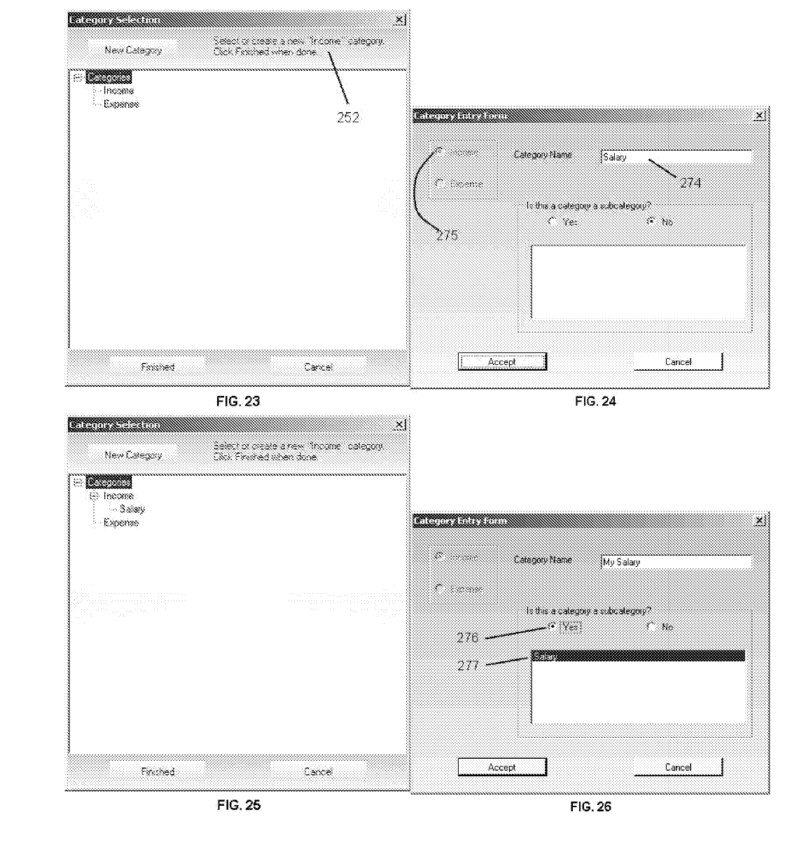

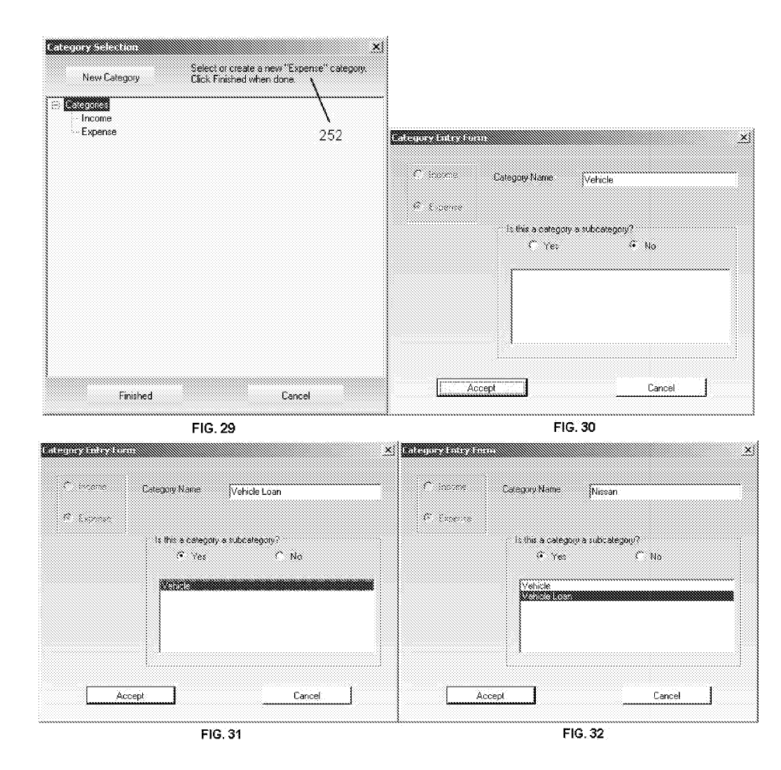

FIG. 23 is displaying the Category Selection from as seen for the first time with no categories entered. Note the description 252 indicates that this is an income category. FIG. 24 is displaying the Category Entry form where new categories are entered. The name of the new category is placed in the Category Name text box 274. The income/expense group 275 displays the type of category that is being created. FIG. 25 is displaying the Category Selection form with the newly created ‘Salary’ category. FIG. 26 the Category Entry form is showing how to create sub-categories. Selecting the ‘Yes’ radio button 276 further allows the selection of a parent category 277. FIG. 29 is displaying the Category Selection form for expenses, as noted in the description 252. Any and all income items will not be seen during the budget creation process.

FIG. 28 is a screenshot of the Payee Load form displaying an example of a Compute end date payee. Notice the yes radio 281 is checked and that a target amount 282 has been entered. Compute end date payees normally represent loan type payees, such as car and boat loans. The New Budget Wizard will stop creating transactions when the loan balance is zero.

FIG. 34, the Payee Load form is displaying a Tithe 284 payee. Since a tithe is 10% of all income for a given period, the amount text box 270 is unavailable for input. The description and category are the only available and required fields on a tithe payee. Tithe transactions are created for every period of the budget. Once created a change in any income transaction will cause the tithe value to re-compute and update the amount.

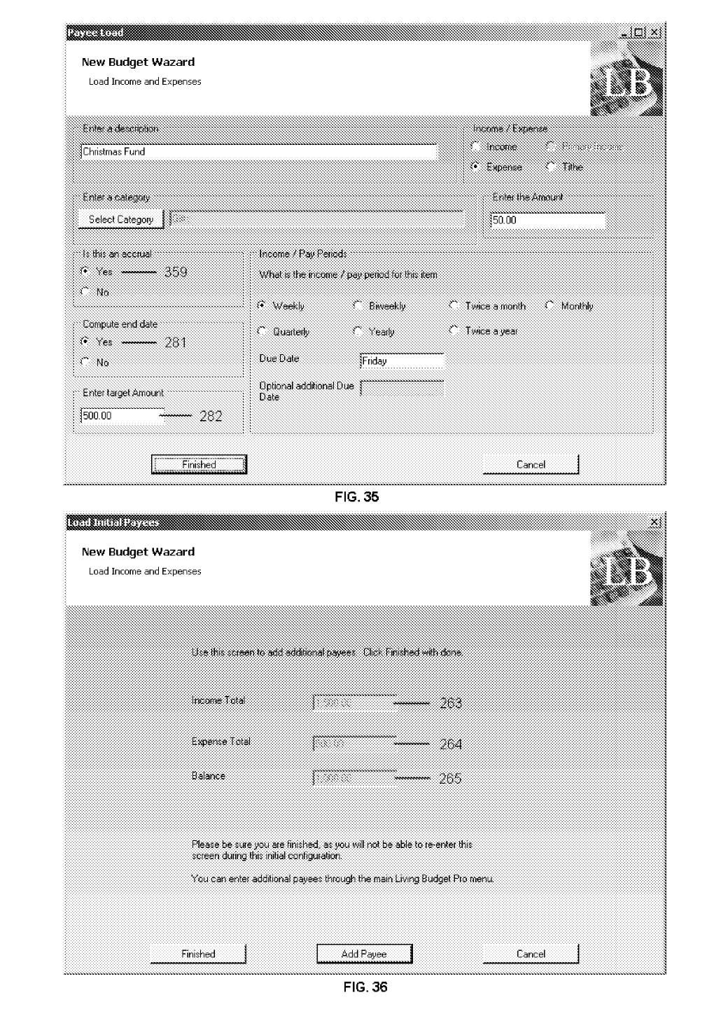

FIG. 35, the Payee Load form is displaying an Accrual payee. Notice the accrual 359 and Compute end date 281 radios are set. The Target amount text box 282 also has been set with a value. Accruals normally represent savings type payees, like saving for birthday or Christmas gifts, or yearly car insurance. The amount is deducted from the Current Balance 214 and placed in the Accrual Balance 219. All monies are still in the primary account, but when accruals are active, the Actual Checkbook Balance 220 represents the total amount. The Current Balance represents the amount of funds that are available at a given period.

FIGS. 30-33 are displaying the steps required to create a category with multiple levels of parents.

FIG. 36, the Load Initial Payees form now has data in the ‘Income Total’ 263, ‘Expense Total’ 264, and ‘Balance’ 265 fields.

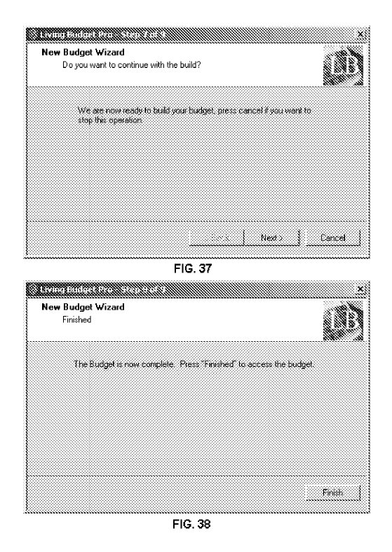

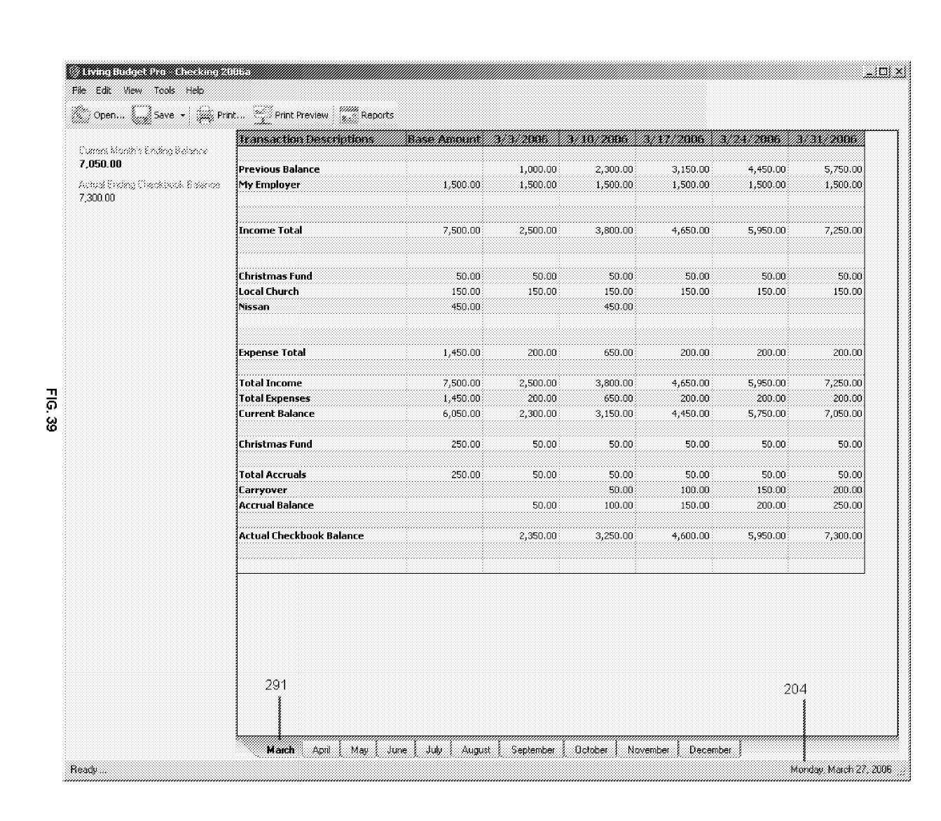

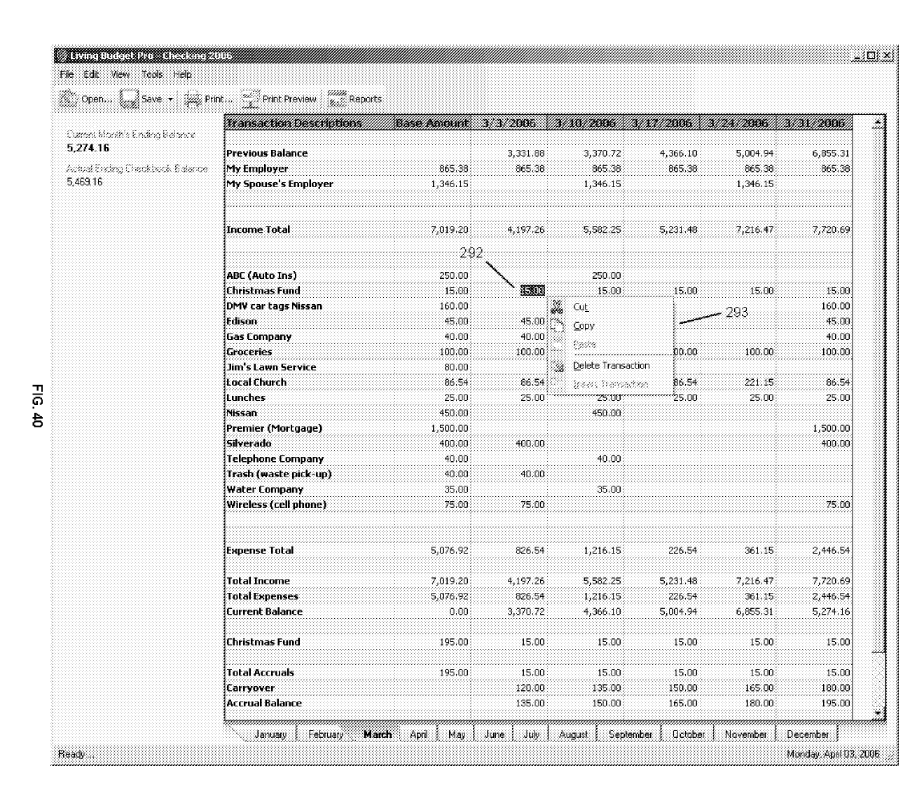

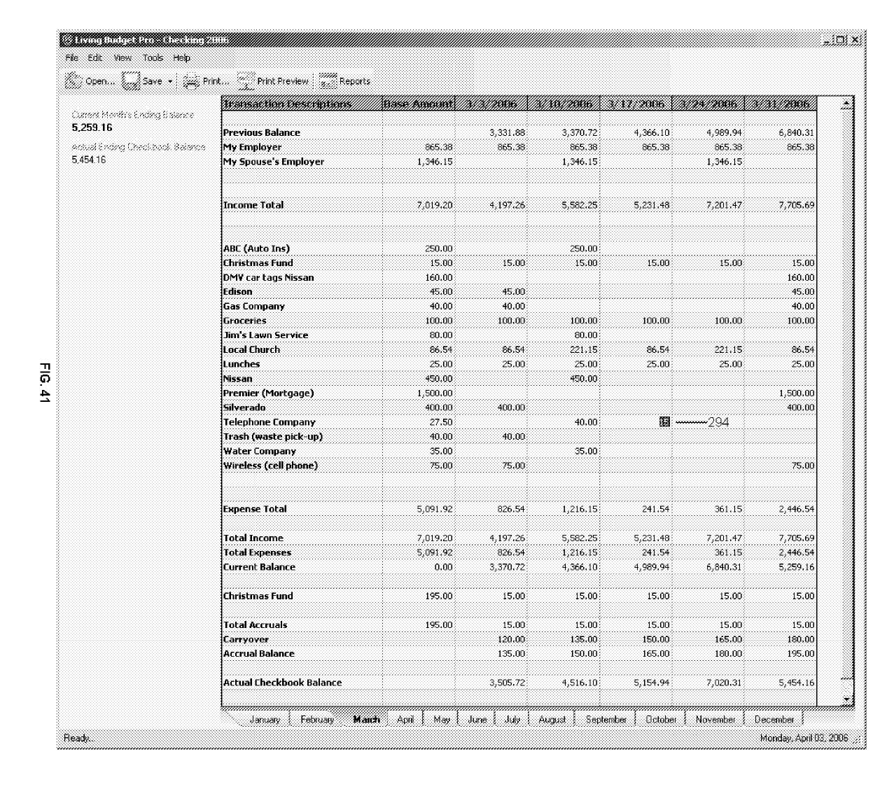

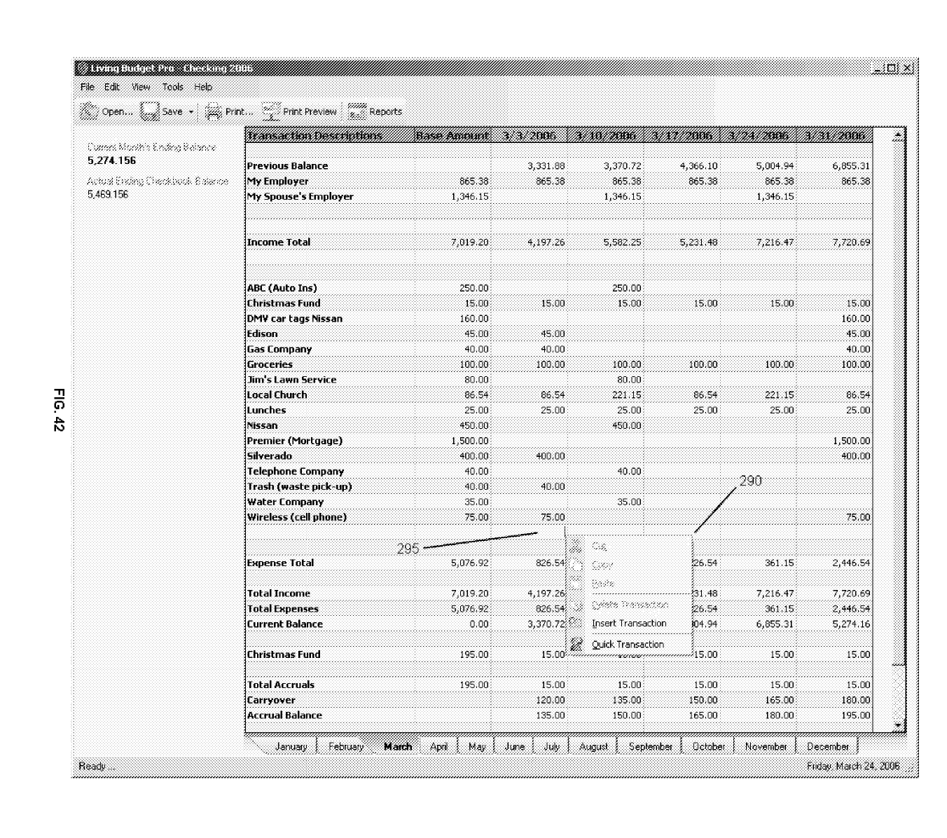

FIG. 37 is a screenshot of Step 7 of the new budget wizard, and provides the last chance to quit before building the new budget. Step 9 of the new budget wizard, not shown, is the final step and displays completion.

FIG. 39 is a screenshot of the newly created sample budget. Notice that the date 204 is Mar. 27, 2006. Please also notice how the first tab 291 is for the month of March. The program only creates budgets for the present month and forward through the end of the current year.

Referring to FIG. 40, various contextual functions including deletions 293 can be accomplished by using a mouse. FIG. 41 shows how easily transactions 294 can be entered into any blank cell.

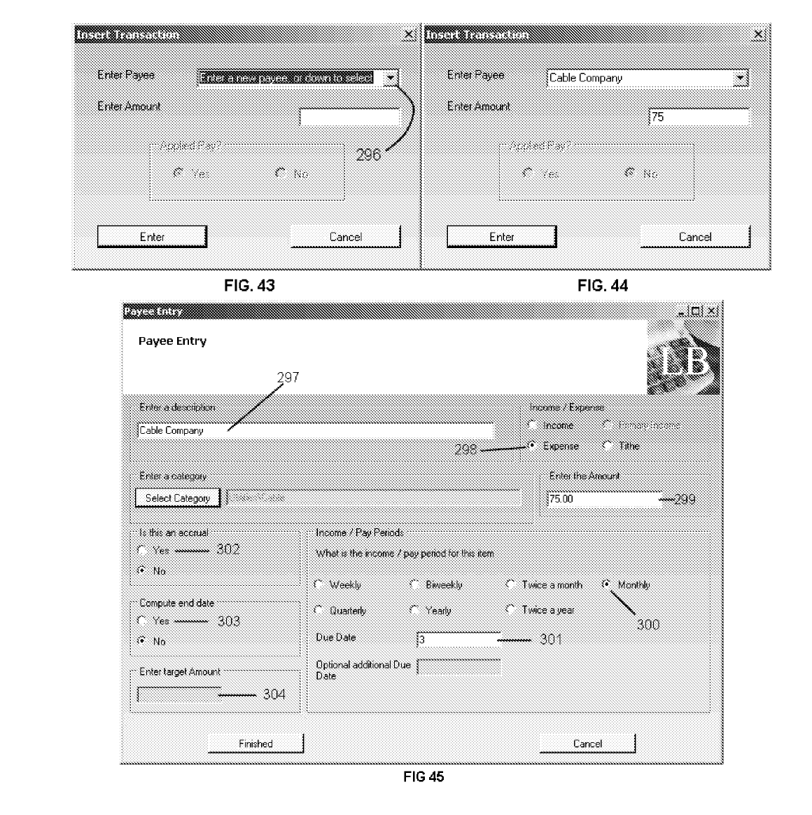

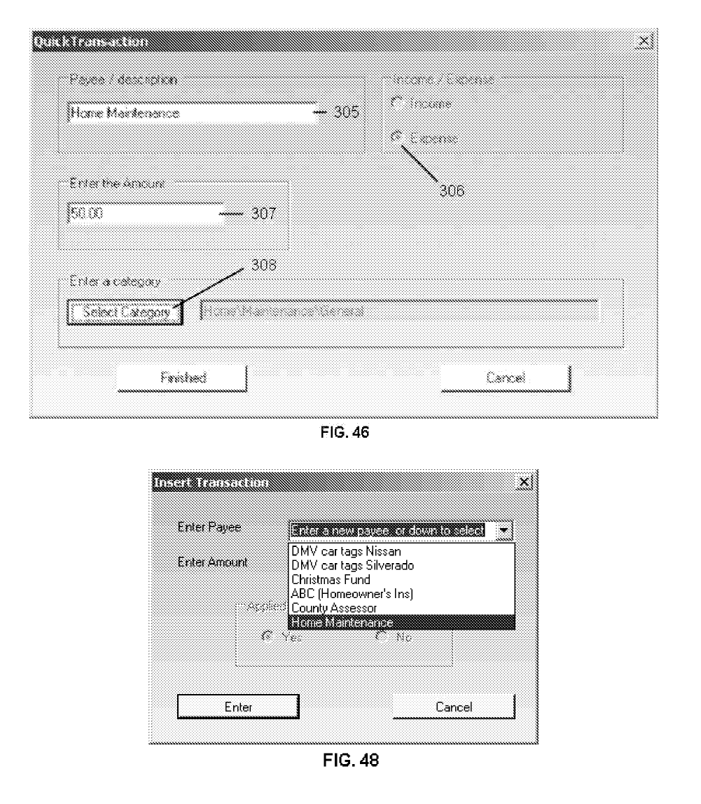

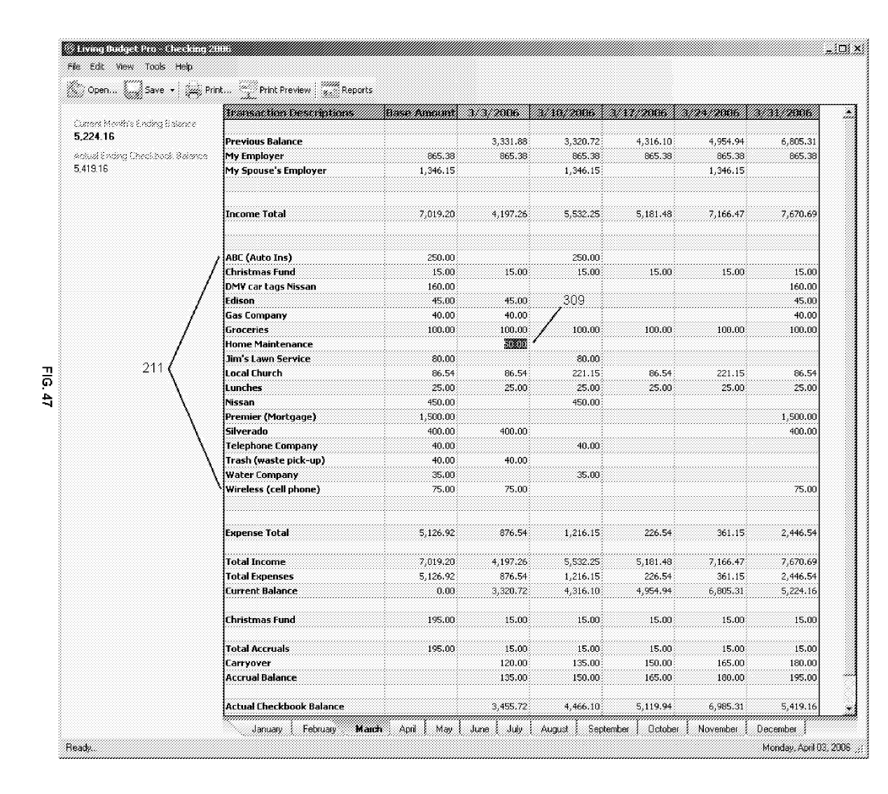

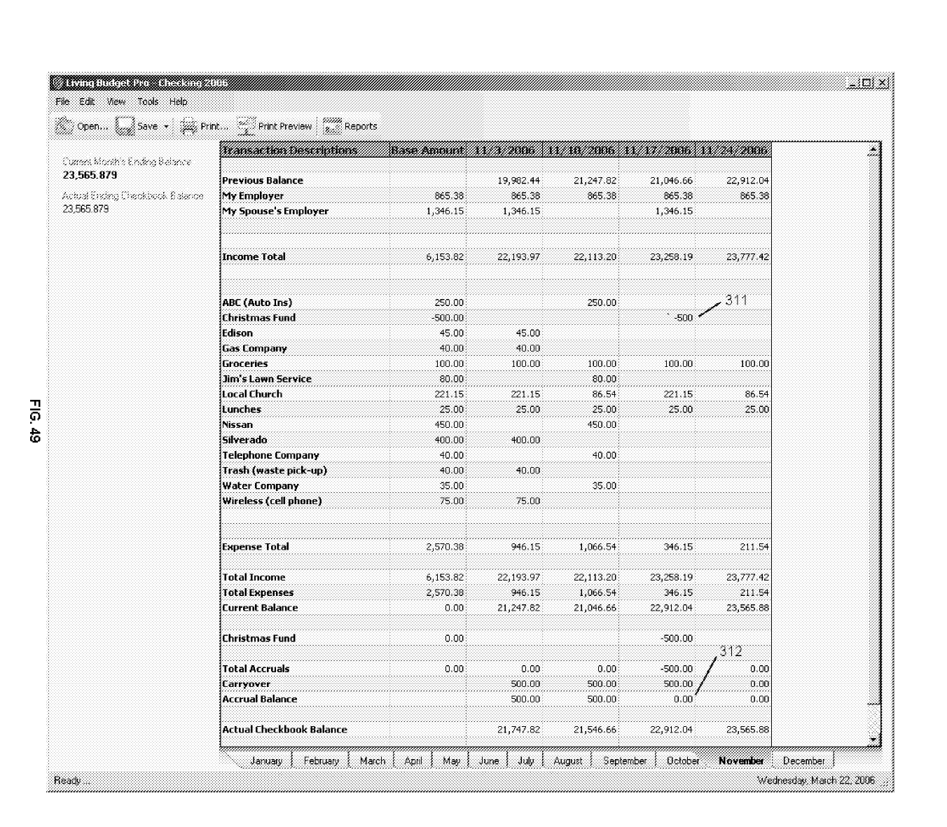

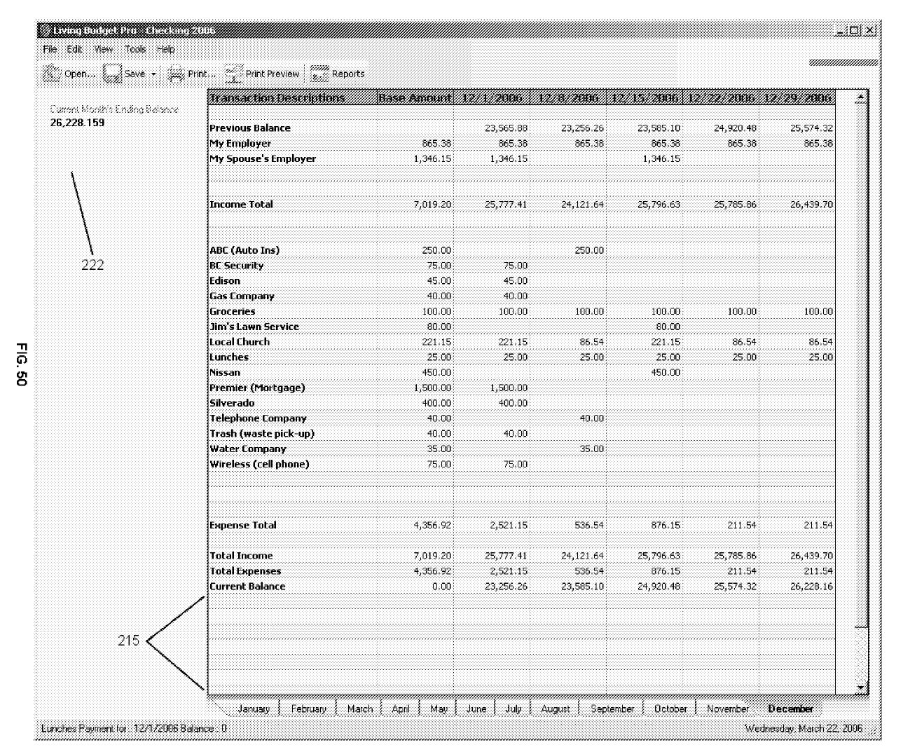

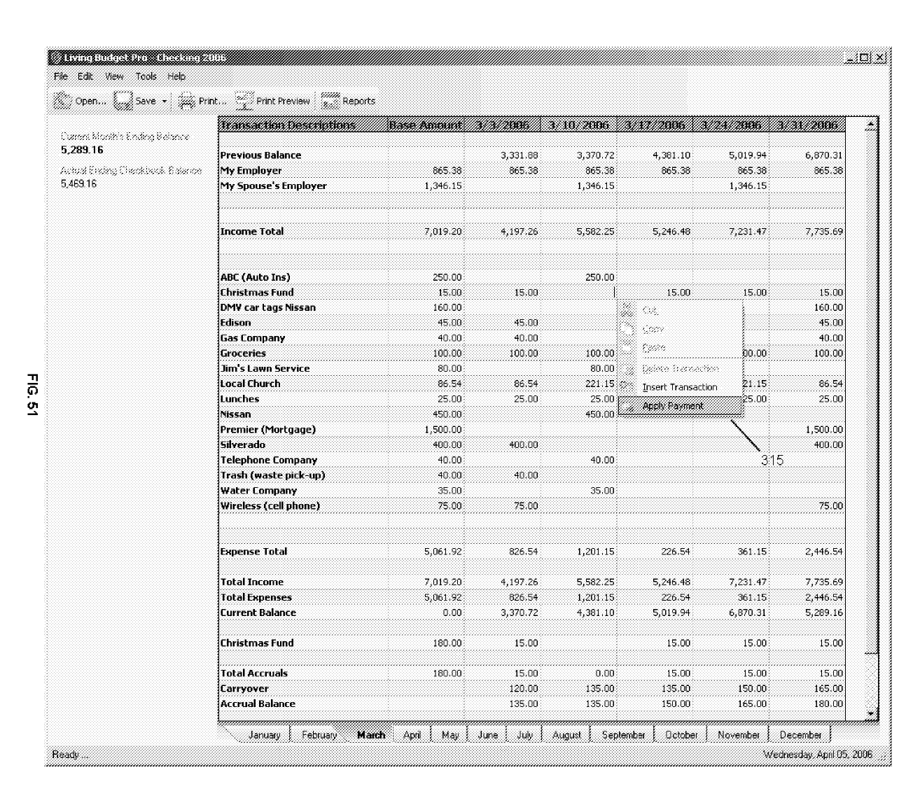

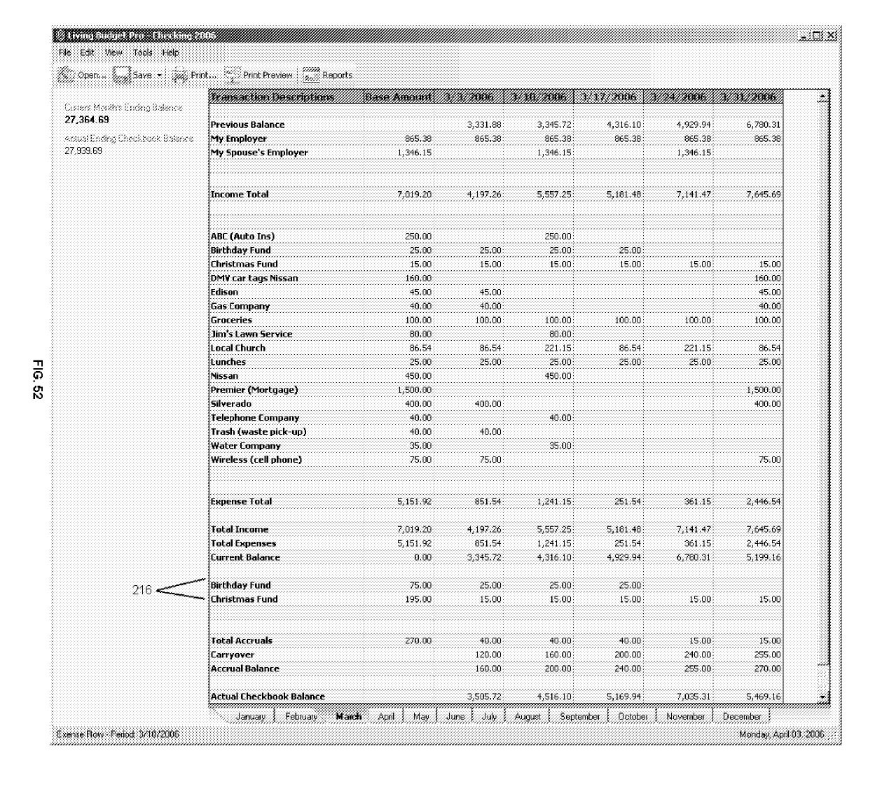

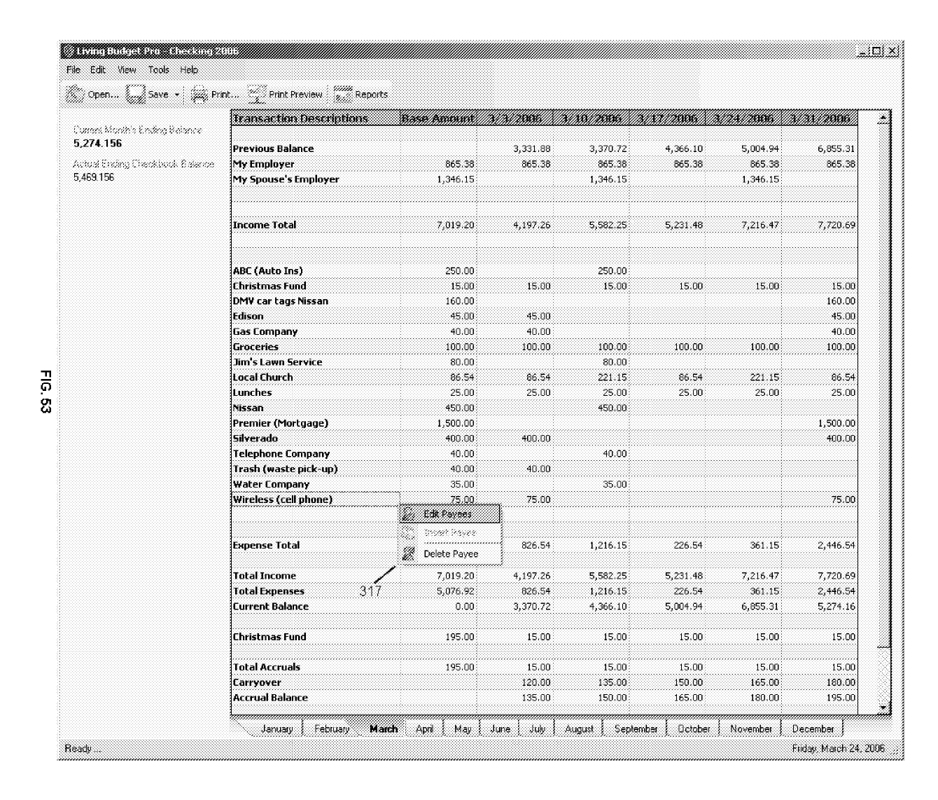

Referring to FIG. 42, insertion of recurring transactions or one-time Quick Transactions is accomplished by right-clicking the mouse on an empty cell 295 on a blank row in either the income or expense sections. Selecting Insert Transaction invokes the form in FIG. 43 where, in this context, the user is prompted to enter a new payee. FIG. 44 shows the completed form and FIG. 45 the Payee Entry form is where the user enters the final information. The description 297 and amount 299 are filled in from the previous form. The Income/Expense type 298 has been selected based on the grid the user selected. The Due Date 301 was also entered based on the selected cell. The Monthly radio button 300 is a default selection for expenses. The default selection for income would be based on the primary income periods for the budget. By default, accruals 302 and Compute end date 303 are not selected. The target amount 304 which is used in conjunction with compute end date alerts the program to stop creating recurring transactions and is unavailable while the compute end date radio is set to “no”. FIG. 46 is a screenshot of the Quick Transaction form. The form requires 3 entries description 305, amount 307, and category 308. The Income type 306 is selected based on the cell location. FIG. 47 shows the newly inserted transaction 309, please note the payees are automatically placed in alphabetical order 211. FIG. 48 shows how a one-time transaction can be recalled for use in later months where they are not displayed on the workspace.

FIG. 49 shows how an applied payment 311 removes the money from the accrual balance 312 and thusly from the main account. If the accrual balance drops to zero, the next month will not display an accrual area as shown in FIG. 50, 215. The Actual Ending Checkbook Balance label and amount is also removed 222. An applied payment can be entered directly by placing a minus sign in front of the number, or by selecting ‘Apply Payment’ from the context menu 315 as shown in FIG. 51. FIG. 52, 216 shows the accrual area with a couple of accruals.

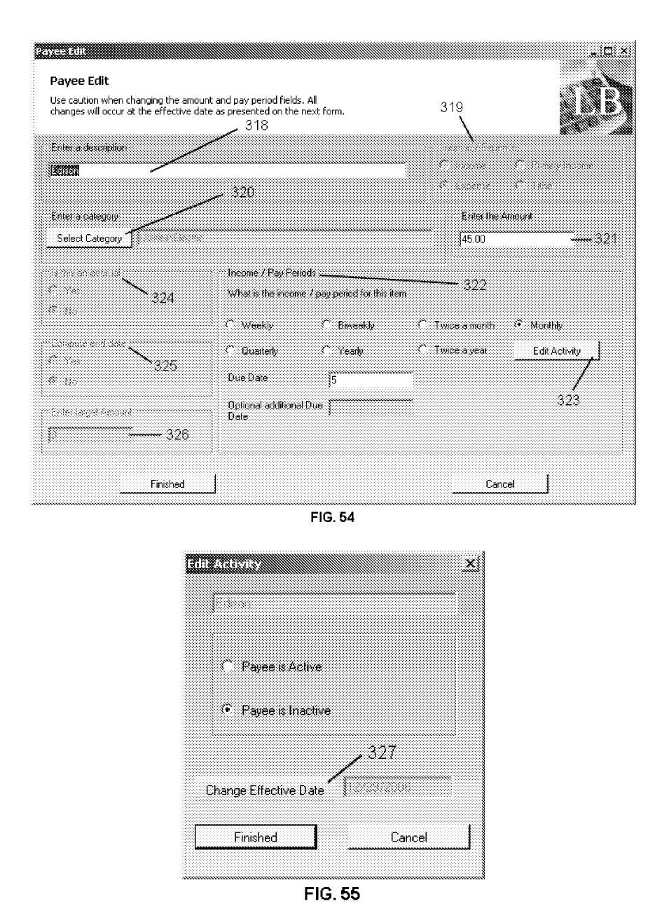

Referring to FIG. 53, the context menu 317 provides a means for editing, deleting or Inserting (creating) payees. FIG. 54 is a screenshot of the Payee Edit form where users can change the description 318, category 320, amount 321, the pay-period group 322, and activity 323. The income/expense group 319, accrual group 324, compute end date group 325, and target amount 326 are un-editable and are grayed (unavailable). The ‘Edit Activity’ button calls the ‘Edit Activity’ form FIG. 55 where the user can make this payee inactive. The ‘Change Effective Date’ button 327 calls a form where the user selects the period when this payee will become inactive. Payee activity is primarily used in deciding which items to select in building next year's budget.

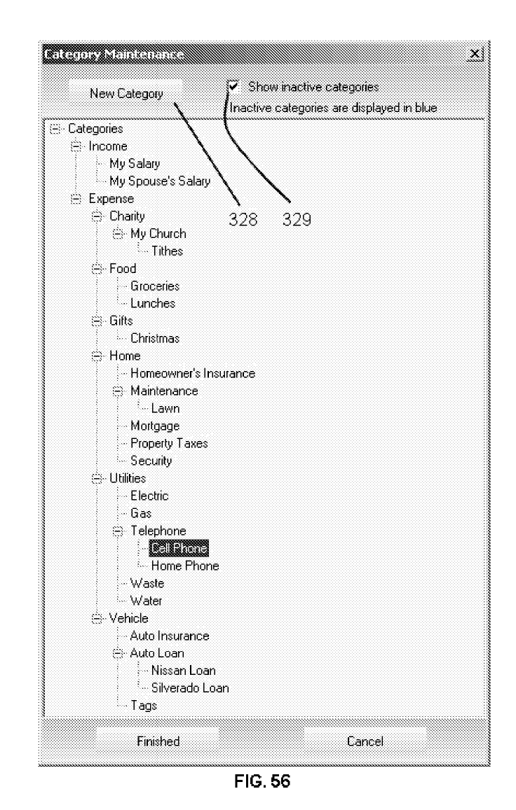

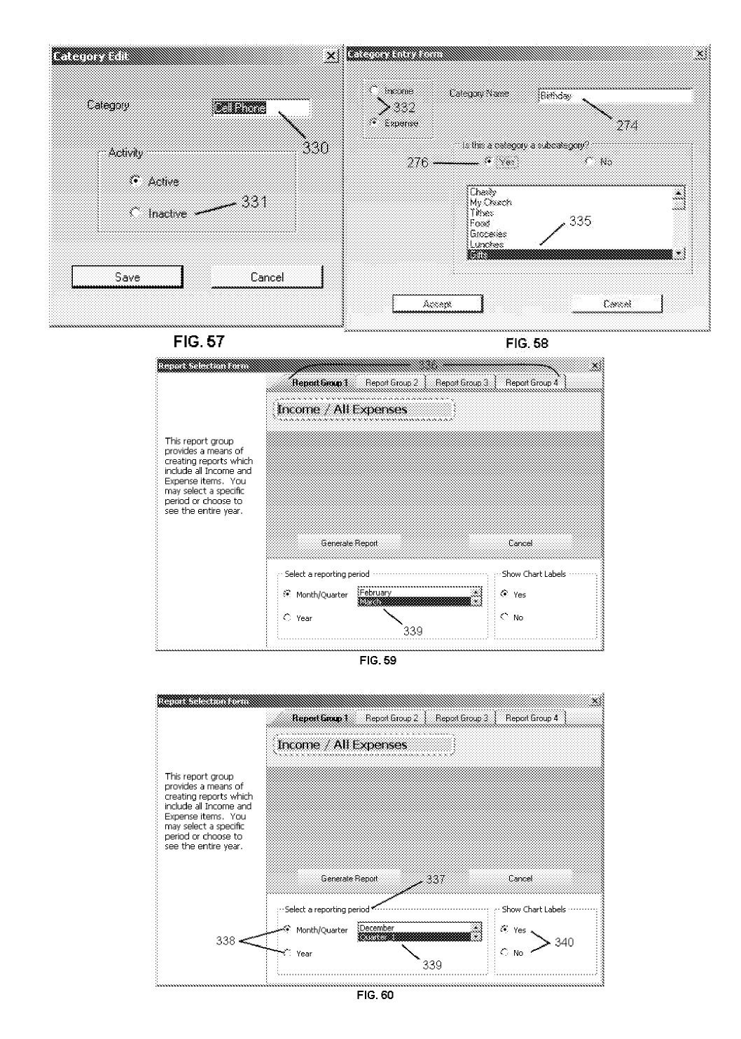

FIG. 56 is a screenshot of the Category Maintenance form which provides a means of creating, renaming or making a category inactive. Referring to FIG. 57 the Category Edit form, the category text box 330 is where the name can be changed. Categories can be made inactive by selecting one of the radio buttons in the activity group 331. FIG. 58 the Category Entry Form provides a means of creating categories. The name text box 274 is where you enter the name of the category. Categories can either be income or expense types 332 and can be a sub-category of another category 276. If this is a sub-category, the user must select a parent category 335.

FIGS. 59-63 are screenshots of the Report Selection Form. Referring to FIG. 59, the form provides a means of selecting various types of reports which are located on the four tabs 336. Report Group 1 produces a report against all Income and all Expenses. The reporting periods are by month, quarter, or year. FIG. 60 shows how a quarter can be selected 339, in this case the first quarter. Only available quarters are shown, so if the first month of the budget is April, the first quarter would not be shown; this also applies to the available months displayed. Radio buttons 338 provide a means of selecting between year and month/quarter reporting. Chart Labels can be turned on or off by selecting the Show Chart Labels radios 340. Chart Labels can be seen in FIG. 64, 343.

FIG. 61 is displaying Report Group 2, all Income and one Expense. This group provides a means for selecting one expense 341 for the report. Additionally, groups 2-4 allow for the selection of a chart style 342. The available chart styles are: Line, 3D Line, Clustered Column, 3D Clustered Column, Pie, and 3D Pie. FIG. 62 is displaying Report Group 3, Selected Expenses. This group allows for the selection of one or more expenses. Finally, FIG. 63 is displaying Report Group 4, Selected Income. This group allows for the selection of one or more income items.

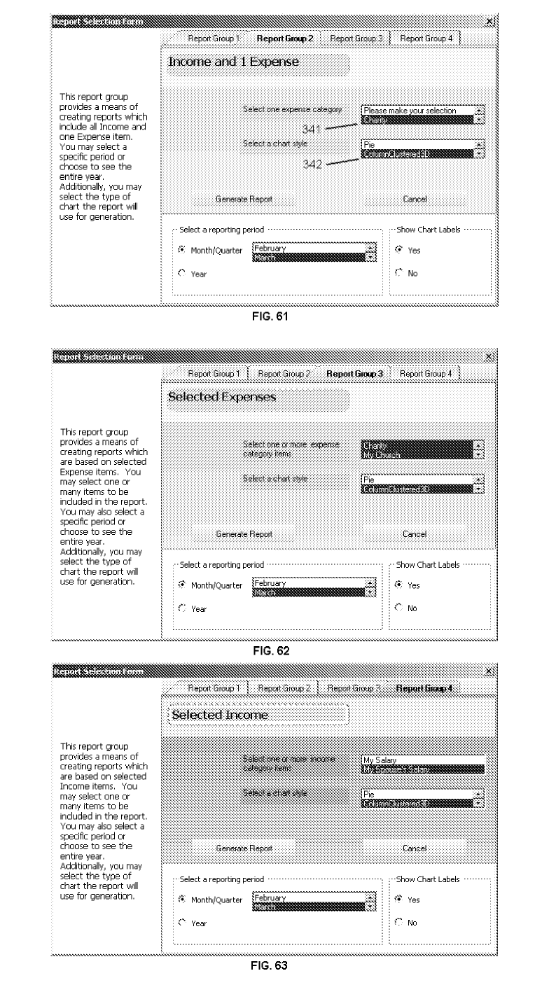

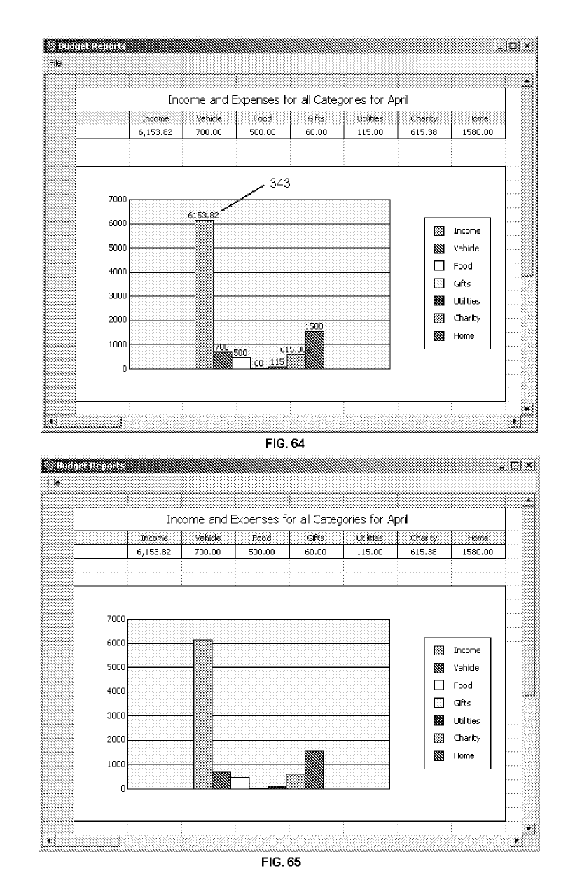

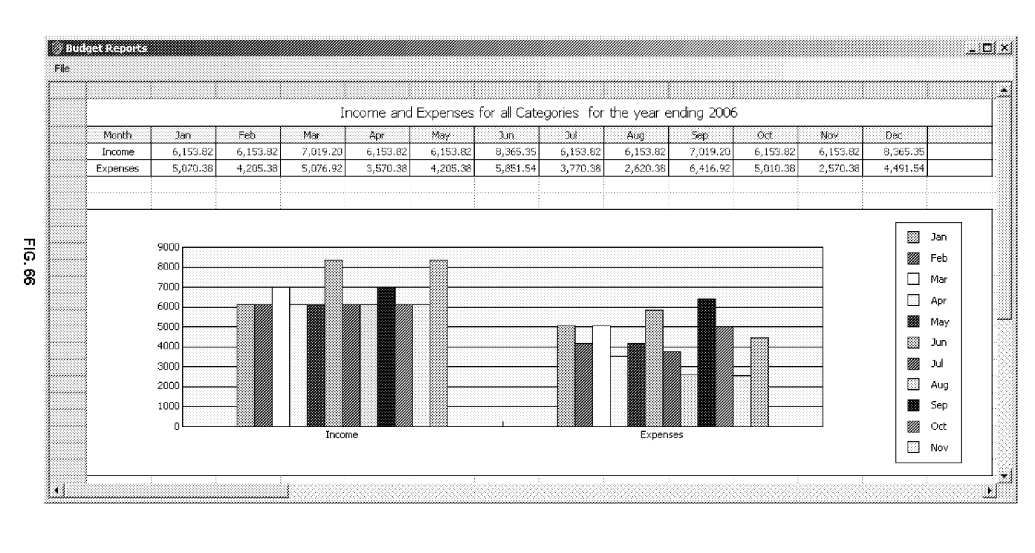

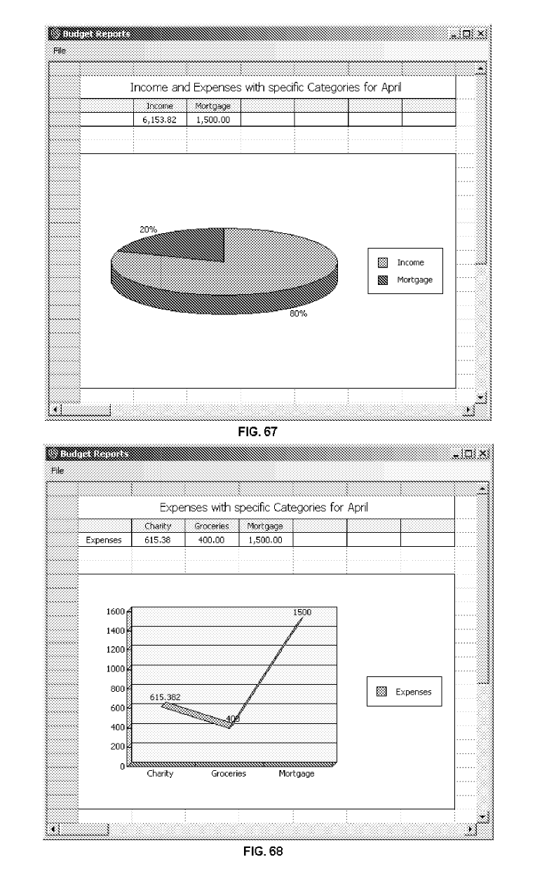

FIGS. 64-69 display the various output reports using the reports selection form. FIG. 64 is a screenshot of the Income with all Expense report for April with chart labels 343. FIG. 65 is the same report without chart labels. Chart Labels are controlled be selecting either of the chart label radio buttons 340 show in FIG. 60. FIG. 66 is the Income with all Expense report for the year. Report Group 2-4 provides the ability to select categories. Group 2 allows for the selection of one category where Groups 3 & 4 allows for the selection of multiple categories. FIG. 67 is a sample report from Report Group 2 and is using the 3D Pie chart. FIG. 62 is a screenshot of Report Group 3 with multiple category selections. FIG. 68 is a sample report from Report Group 3 and it is using a 3D Line chart. FIG. 63 is a screenshot of Report Group 4 and FIG. 69 is a sample report using the Column Clustered 3D chart.

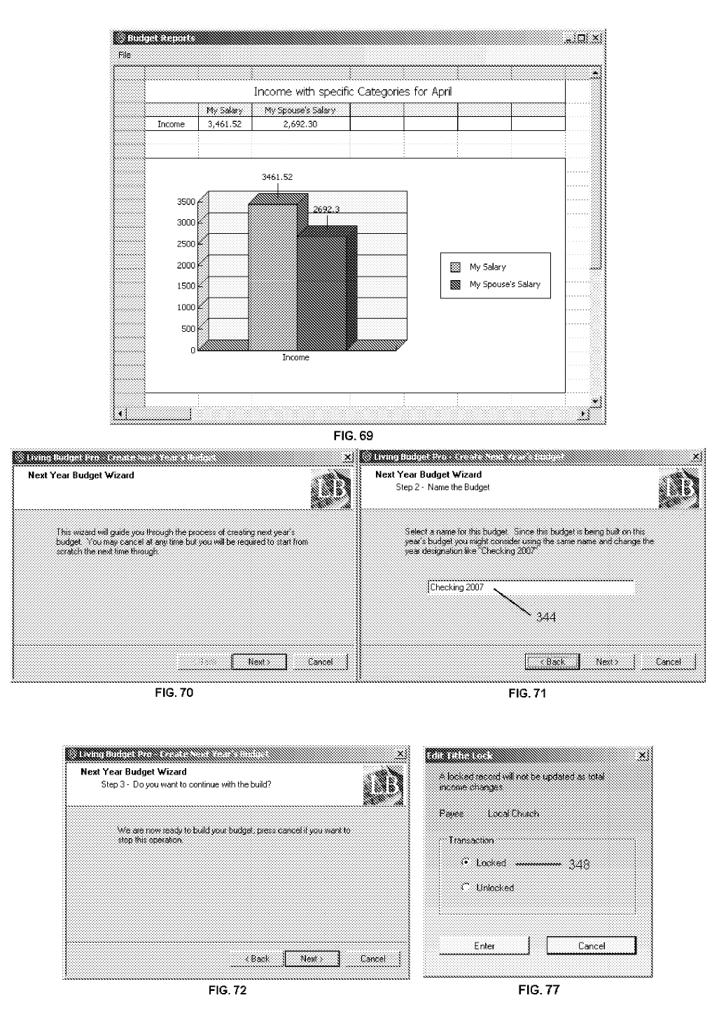

FIGS. 70-72 are screenshots of the Next Year Budget Wizard. Since each year has different periods, the program provides a way to create a new budget for the upcoming year based on the current year's data. FIG. 70 is a screenshot of the initial form. Since each year's budget is different, each budget must have a unique name. FIG. 71, displays a text box 344 which requires a new name for the budget. The name must be different from the budget that will be used to create this budget. A final form, not shown, displays completion prior to displaying the new budget. FIG. 74 is a screenshot of the newly created 2007 budget.

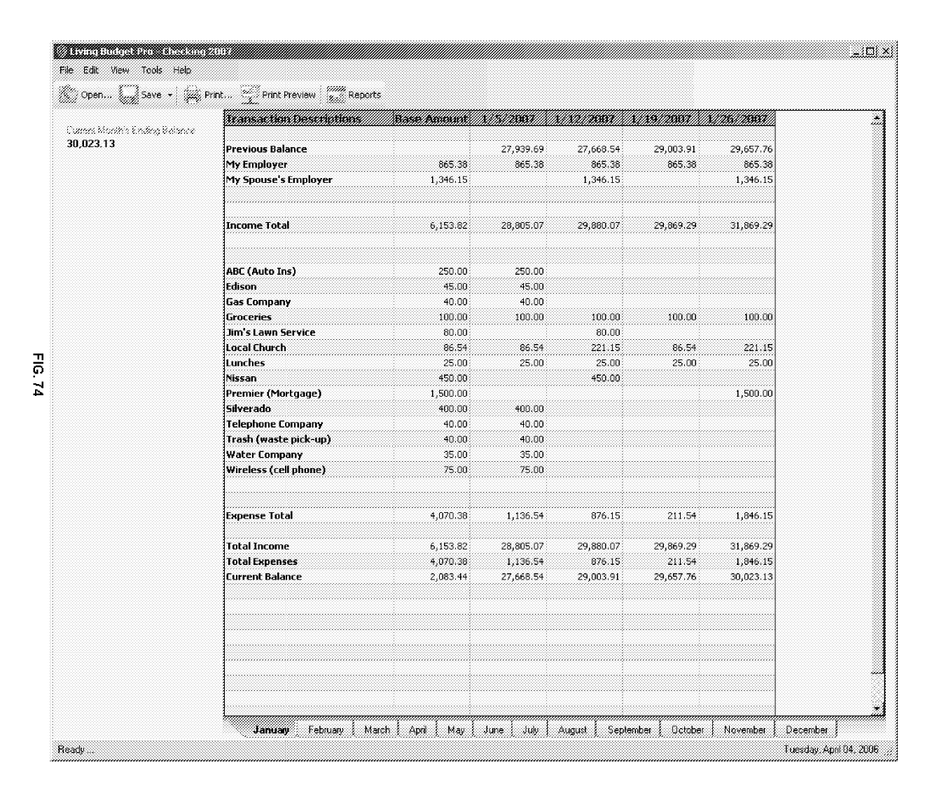

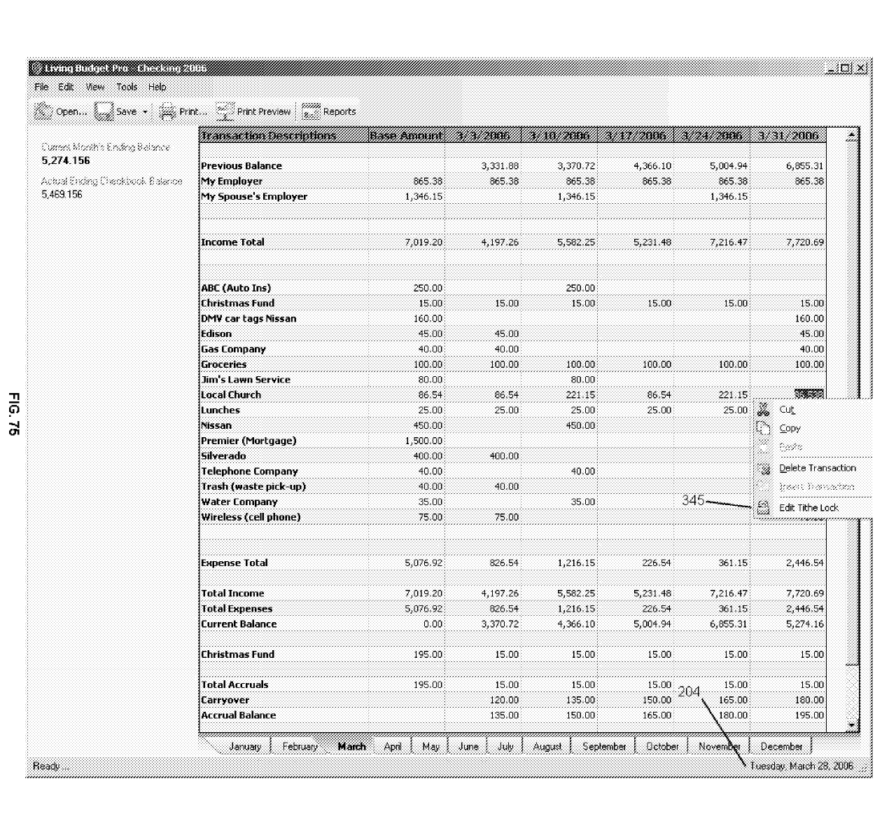

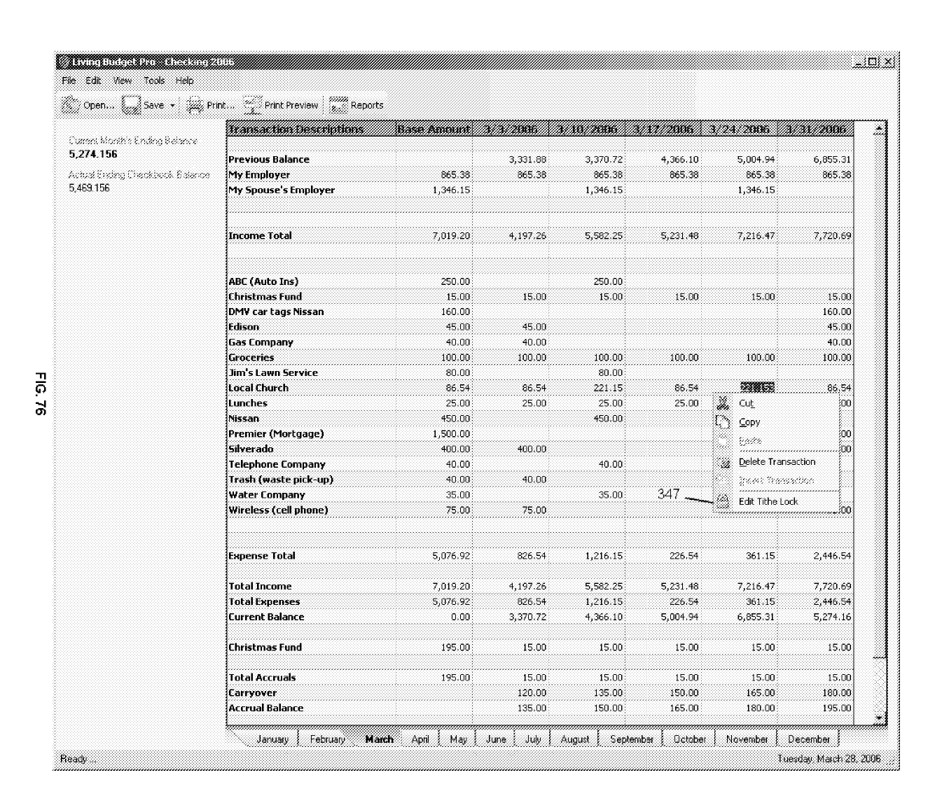

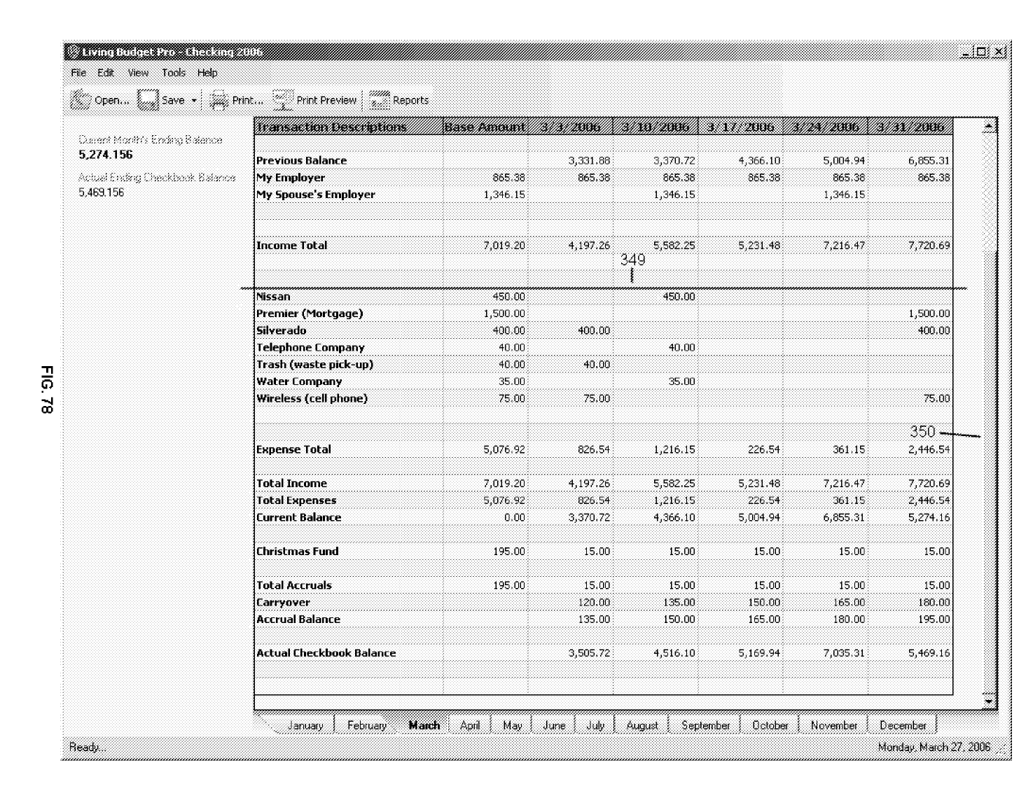

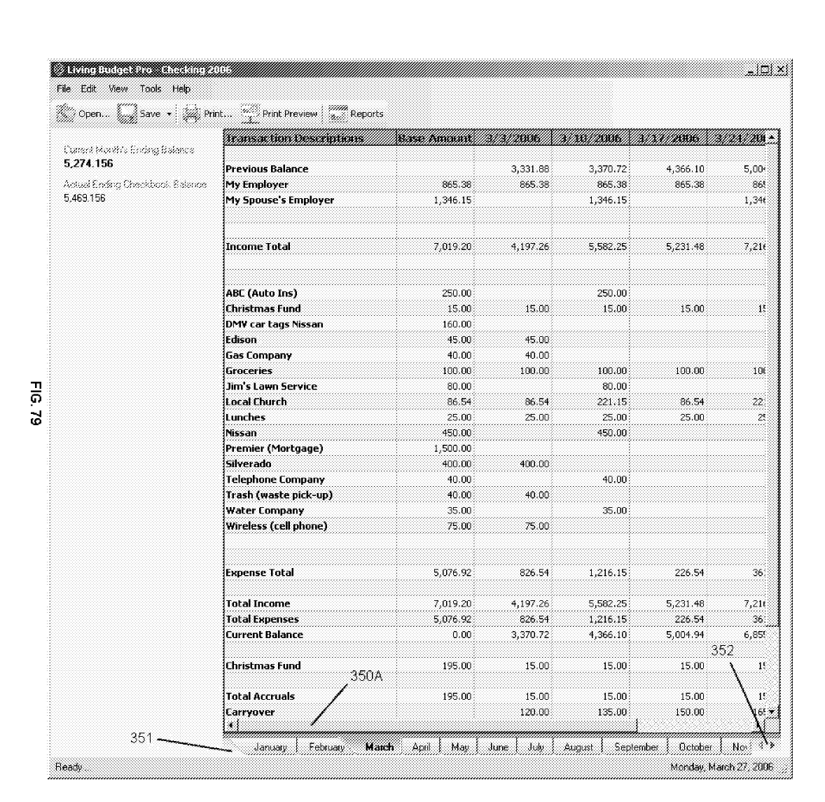

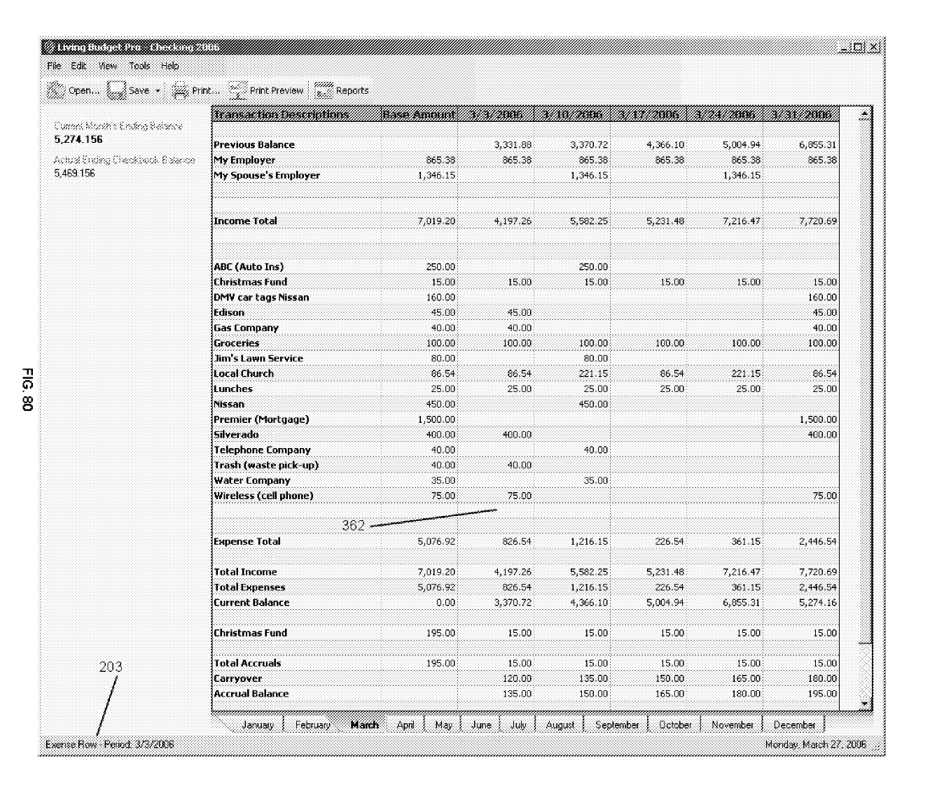

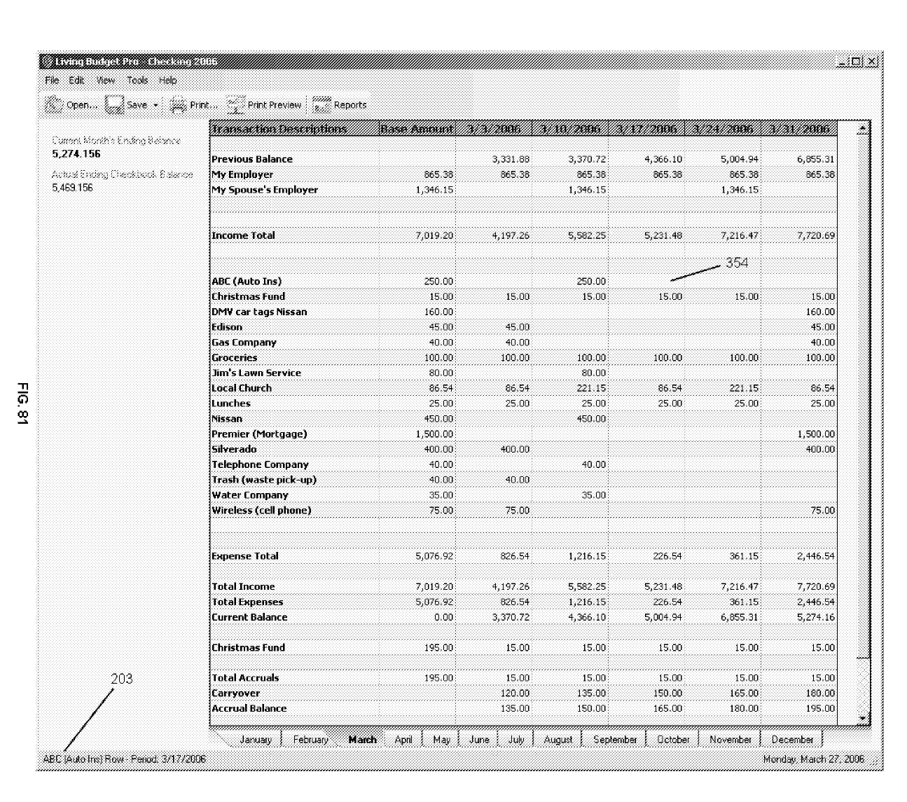

FIGS. 75-77 relate to the Tithe function built into the product. Tithe transactions are 10% of the total income within a given period. Since the total income could change at any time the tithe value would also change. Provision was made so tithe transactions could be locked, meaning that updates to the income would not cause an update to the tithe transaction. This provision also provided a means for the user to change the values since previously, changes would trigger an update and insert the 10% value back into the cell. The context menu 345 in FIG. 75 ‘Edit Tithe Lock’ indicates the transaction is unlocked by displaying an open lock. Notice also that the current date 204 is Mar. 28, 2006. The program always locks all tithe transactions prior to the current date. So the transaction for period Mar. 31, 2006 is unlocked. FIG. 76 shows the tithe transaction for period Mar. 24, 2006 is locked 347. FIG. 77 is displaying the Edit Tithe Lock form where the state of the lock can be changed by selecting the appropriate radio button 348.

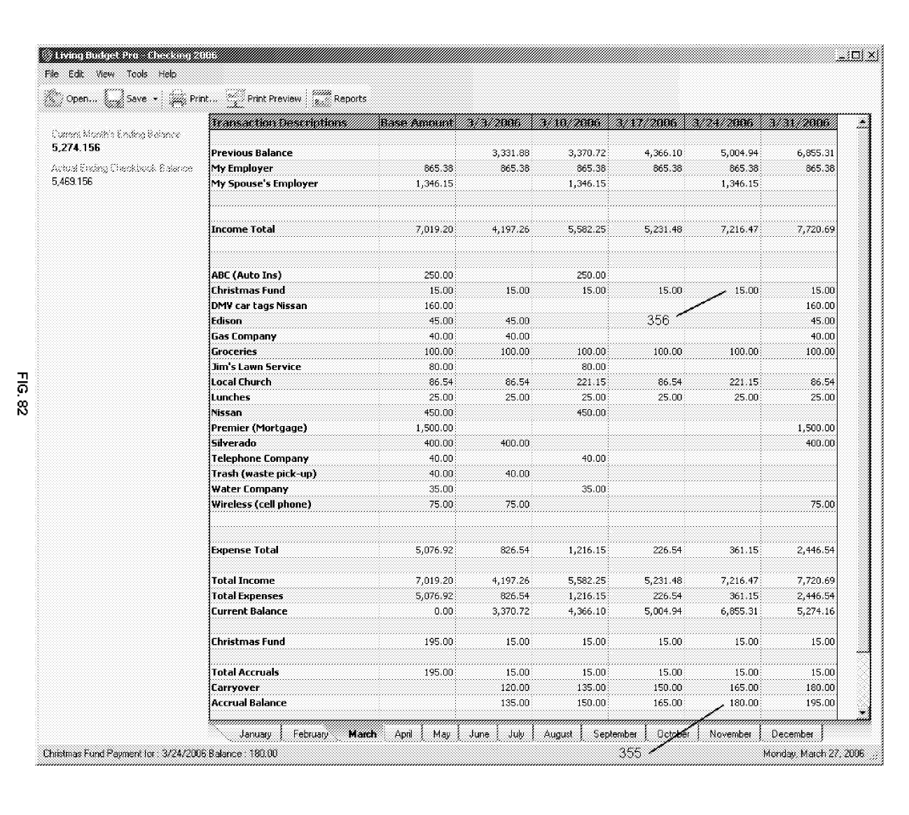

FIG. 78 is a screenshot of the main workspace and is displaying the results of vertical scrolling with the scroll bar 350. Specifically, the workspace scrolls up into the first row of the expense group 349. This type of vertical scrolling provides enhanced context to the overall display. FIG. 79 is also a screenshot of the main workspace, but is displaying horizontal scrolling. Besides showing the horizontal scrollbar 350A, the tab-bar 351 has scroll arrows 352 to accommodate selecting hidden tabs.

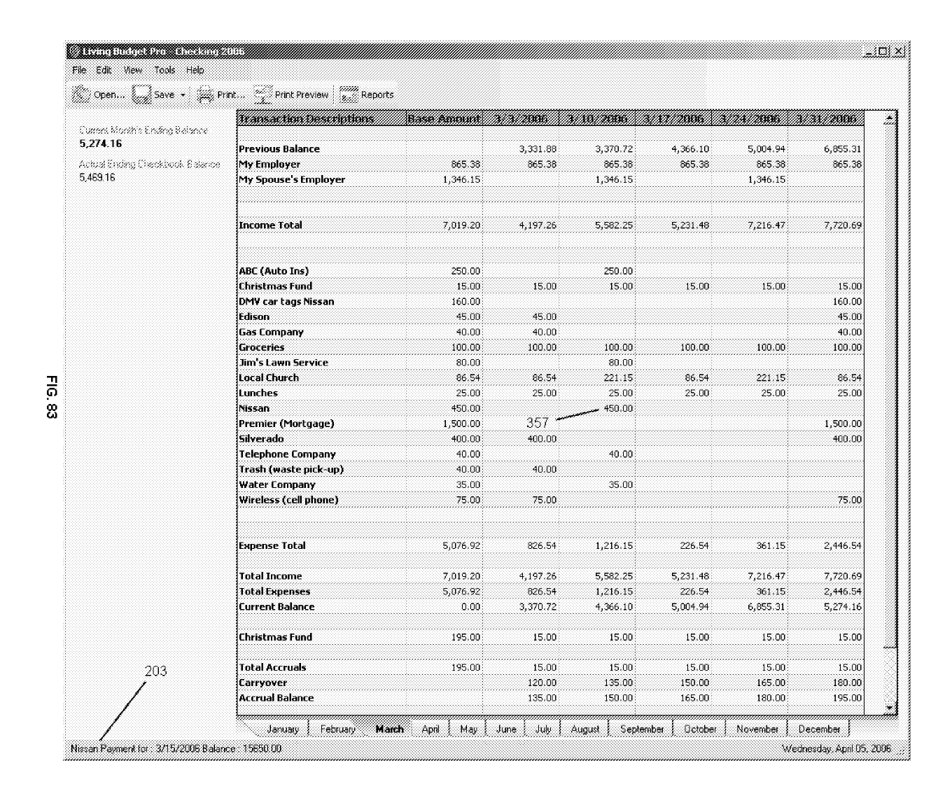

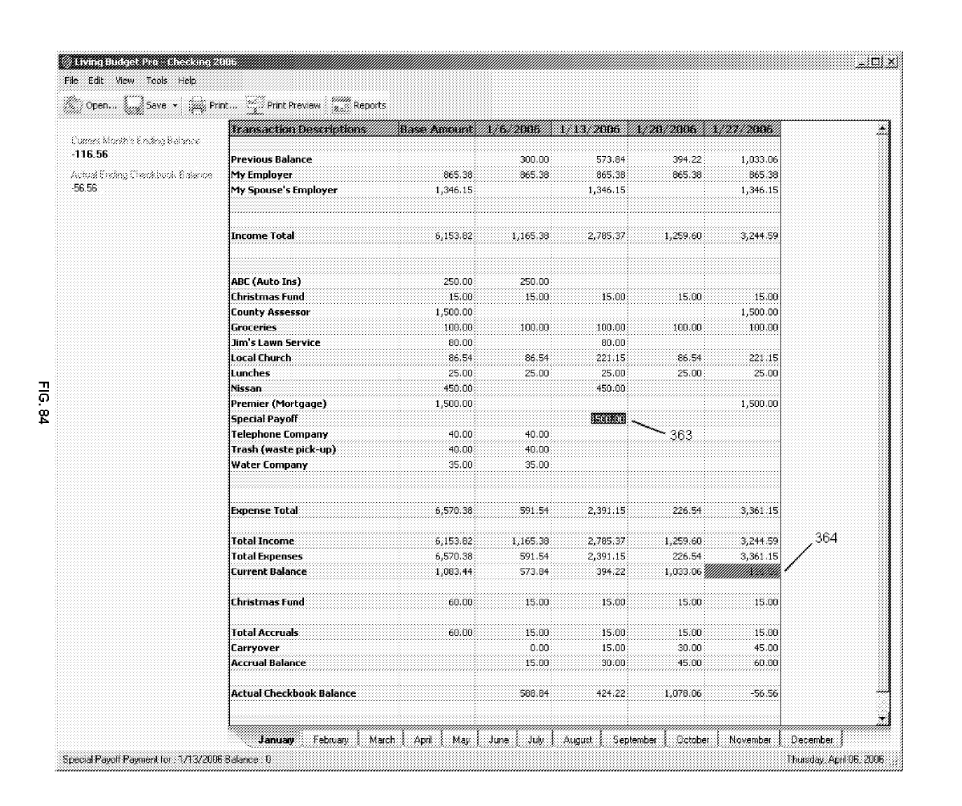

Referring to FIG. 80 which is a screenshot of the main workspace, notice the status indicator 203 is displaying information regarding the current cell where the cursor is hovering 362. These visual indicators are helpful when creating, editing, or deleting transactions. Specifically, showing expense rows or income rows and the periods ensures the user selects the proper cell. The status indicator 203 in FIG. 81 is alerting the user that the cursor 354 is positioned on the ‘ABC (Auto Ins)’ row in period Mar. 17, 2006. The status indicator also displays the balance of accruals 356 as show in FIG. 82. Additionally, since the program pays all payees on or before the pay date, the status indicator 203 will display the payment for the transaction pointed to by the mouse 357, as seen in FIG. 83. Please also note in FIG. 83 that the status indicator is providing a balance for this Compute end date payee. The balance for a Compute end date payee decreases every period paid. Accrual balances increase every period until the target amount is met.

Whenever the current balance is negative, the cell color will change to red 364 as shown in FIG. 84 providing a visual indication of a problem.

### Operation—Preferred Embodiment—FIGS. 1-84

The purpose of the Living Budget financial management application is to mange living budgets. The present embodiment of the application is presented in and uses the Microsoft Windows operating system. Mouse functions as described herein are based on a two button mouse. Although the current embodiment utilizes the Windows operating system and features, this should not limit the scope of the product. Future embodiments of this application will be made available in other operating systems such as Apple which utilize a single button mouse.

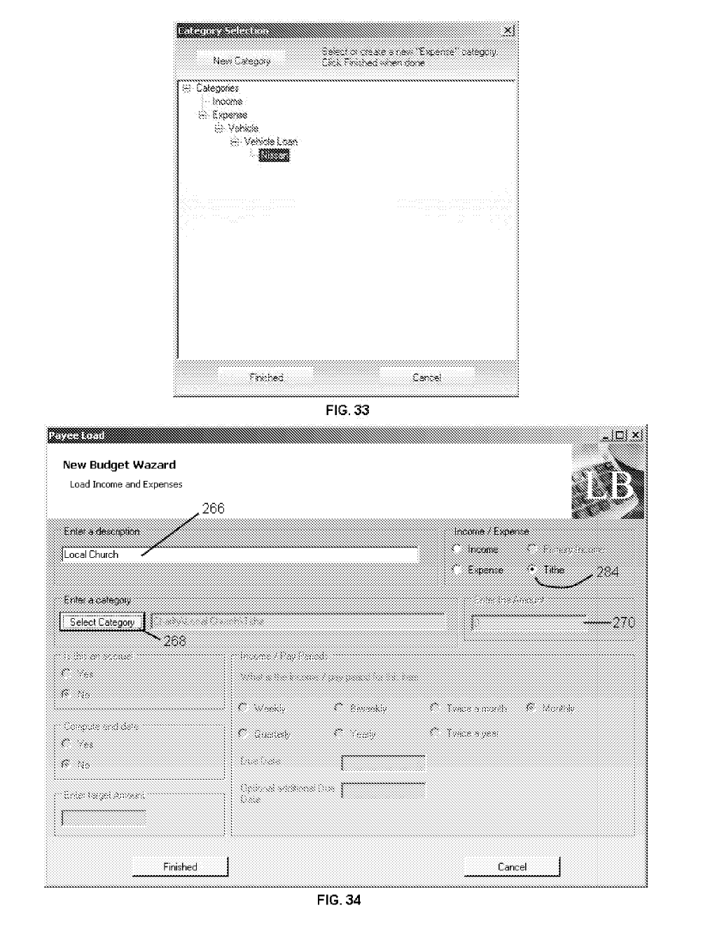

FIG. 1 shows the program with a fully loaded sample living budget. To create a living budget, select ‘New Budget’ from the file menu 227 in FIG. 2. Alternately, you can use the keyboard combination ‘CTRL+N’ to being up the New Budget Wizard as displayed in FIG. 9. Clicking the Next button brings up the form in FIG. 10 where you are prompted to name 253 this budget. Naming the budget is mandatory and you cannot proceed without entering a name. Clicking the Next button advances you to step 3 where you are given the choice of creating a budget for this year, or for next year 254 see FIG. 11. This option was provided for people who receive the product in December and want to start fresh in January. Click the Next button to advance to step 4 where you are given the option of using the Override Pay option as displayed in FIG. 12. The Override Pay option was designed for those individuals who receive pay at irregular intervals but must pay bills regularly. For example some contractors only get paid while working and might not get paid during parts of the winter when they cannot work. Override Pay would also work for those teachers who only get paid ten months of the year. Clicking the Add Override button will invoke the Override Pay form as displayed in FIG. 16. The Pay Period group box provides four options: Weekly, Biweekly, Twice a Month, and Monthly. The program will use this selection to produce a budget with the selected amount of periods 208 per month, see FIG. 1. FIG. 22 is the matrix of valid entries for the selections. Clicking Finished will return you to step 4 as displayed in FIG. 12. Clicking the Next button advances you to step 5 FIG. 18, where you are prompted to enter an initial balance 260 for this budget. The initial balance is useful and provides a why to start the budget with a reconciled amount. Click the Next button to move to step 6 FIG. 19, where you are given the option of Entering Payees, going back, or canceling. Clicking the enter Payees button will bring up the Load Initial Payees form as displayed in FIG. 20. From this form each payee is added one-by-one until the user is either finished or decides to cancel the operation. The form updates the Income Total 263, Expense Total 264, and Balance fields 265 for each new payee. Income payees increase the Income Total, and expense payees increase the Expense Total fields. The balance field is the result of subtracting the Expense Total from the Income Total. Clicking the Add Payee button loads the Payee Load form as displayed in FIG. 21. First please note that if the Override Pay option was not selected, the payee type under ‘Income/Expense’ is set to Primary Income 267 with all other options unavailable. If the Override Pay option was selected, the payee type would be set to ‘Expense’ with all other options except ‘Primary Income’ available. Continuing with the no Override option, the first payee is the employer with the greatest pay frequency. If for example the husband gets paid biweekly and the wife gets paid weekly, then her employer would be entered first as the primary income payee. Her employer's name is entered in the description box 266. Next click the ‘Select Category’ button 268 to create the category that is applicable to this payee. The Category Selection form is displayed as in FIG. 23. Next click the New Category button to add a new income category. The Category Entry form is displayed as show in FIG. 24. Enter a category name 274 for this category. Notice that the program knows this is an income 275 category. Click ‘Accept’ to create the category. FIG. 25 shows the newly created category. Click ‘New Category’ to create an additional category. The Category Entry form is again displayed as in FIG. 26. Enter a name for the category and click the ‘Yes’ radio button 276 to select a parent category. Click ‘Salary’ 277 to select it as the parent. Click ‘Accept’ to continue. Now click ‘My Salary 278, FIG. 27 to select it as our target category. Click ‘Finished’ to proceed. Referring back to FIG. 21, you should notice that the new category is displayed in the category text box 269. Now we shall enter an amount 270 for this payee. The amount is the amount of income you receive from this payee. Next select a pay-period from the ‘Income/Pay Periods’ group box 271. Again, FIG. 22 is a matrix of the valid entries for the available selections. In FIG. 21 we have chosen weekly pay-periods occurring on Fridays 272. Click ‘Finished’ to save the payee. We are now back to FIG. 20, but let's enter a few more payees to expand on some options. Click ‘Add Payee’ to enter another payee. FIG. 28 shows an expense type payee for an automobile. Please notice the payee type as indicated by the checked Expense radio 280 in the ‘Income/Expense’ group box. Also note that ‘Primary Income’ radio 279 is unavailable. Let's go through the process of creating the first expense category by clicking the ‘Select Category’ button. FIG. 29 is displayed, since this is an expense type category the income category we created is not visible. Let's create the new category by clicking the ‘New Category’ button. FIG. 30 is displaying the ‘Category Entry’ form with our new category “Vehicle”. Click ‘Accept’ to save the category. Click the ‘New Category’ button to add a new category. Again FIG. 31 shows our new entry, but this time we have chosen to select “Vehicle” as a parent category. Save the category and create another category. FIG. 32 shows our final category which is “Nissan”, and we have chosen the previous category “Vehicle Loan” as the parent. FIG. 33 is displaying the final category “Nissan” which we click to select. (Please note that right-clicking any category will bring up a context menu which contains: Edit, and New. Clicking ‘New’ on an existing category automatically selects that node as the parent.) Clicking ‘Finished’ brings us back to FIG. 28. Since this payee represents a vehicle loan, the Compute end date radio 281 is selected and the loan balance has been entered into the target amount text box 282. Click ‘Finished’ to save this payee. FIG. 34 is an example of a Tithe payee 284. Notice that the only entry fields on a Tithe payee is the Description 266 and Category 268. This is because the amount 270 of a Tithe payee is 10% of the income for a given period. Periods are not selected because Tithe payee transactions exist on every period generated by the program. Our final example is an Accrual payee as show in FIG. 35. Please notice the Accrual 359 and Compute end date 281 radios are checked. Please also notice a target amount 282 of $500.00 has been entered. By checking Compute end date and entering a target amount, the program will stop creating transactions once the target amount is reached. If Compute end date was not checked, the program would create transaction for the entire year. Clicking ‘Finished’ to save the payee returns us again to the ‘Load Initial Payees’ form as displayed in FIG. 36. Please notice the Income Total 263, Expense Total 264, and Balance fields 265 have been populated. Clicking ‘Finished’ advances us to step 7 as displayed in FIG. 37. Clicking ‘Next’ will advance us to step 8 momentarily. Step 8 displays progress bars that provides a visual indication of the build progress and once complete advances to step 9 which displays completion. Clicking ‘Finished’ displays the sample budget shown in FIG. 39 and also displays a save dialog (not shown) so the user can ensure the work is saved.

In FIG. 39, notice the system date 204 is Mar. 27, 2006, and the first month displayed is March, 291; this is because the program only creates months starting with the current month through the end of the current year. The number of periods displayed in a month depends on the periods specified by the primary income payee, or the Override Pay form. The program is designed to pay each payee on or before the due date and will create transactions appropriately.

Now that we have created a Living Budget, I will address the layout and functionality of the main screen as displayed in FIG. 1. First, I am defining the workspace as the grid area of the main display. There are 12 separate workspaces contained within the 12 tabs 205 representing the months of the year. The main screen is window that houses the application.

The names/descriptions of the payees are displayed in the ‘Transactions Descriptions’ column 206. The payee's amount, at least initially is placed in the ‘Base Amount’ column 207. A variable amount of periods is displayed in period columns 208. The very first previous balance (first period of budget year) located in the Previous Balance row 209 is the Initial Balance, while the other periods contain the balance from the previous period's current balance 214.

Every Income payee we created will be placed in the income area 210 with updated totals for each period in the Income Total row 210A. All Expense payees are displayed in the expense area 211 with corresponding period totals in the Expense Total row 211A. The Total Income row 212 is the value of the Income Total row 210A. The Total Expenses row 213 is the value of the Expense Total row 11A. The Current Balance row 214 is the result of subtracting the Total Expenses row 213 from the Total Income row 212.

If accruals are present, meaning there is an accrual balance, the accrual area 215 will be populated, otherwise the accrual area would be blank. Accrual rows 216 increase and decrease as accruals are added and removed. Accruals 225 are listed in the expense area 211, which are deducted from the active account; the same accrual 226 is then added to the accrual area 215. The Total Accruals row 217 is the summation of all accruals for a given period. The Carryover row 218 is the value of the total accruals from the previous period. The Accrual balance row 219 is the summation of the Total Accruals 217 and the Carryover 218 for a given period. The Actual Checkbook Balance 220 is the summation of the Current Balance 214 and the Accrual Balance 219. The Current Month's Ending Balance 221 comes from the last period of the Current Balance row 223 and is provided as a quick reference. The Actual Ending Checkbook Balance 222 comes from the last period of the Actual Checkbook Balance row 224 and is also provided for reference; this label and value is only visible where an accrual balance is present within the current month. The income area 210 is separated from the expense area 211 for clarity. The Income Total 210A, Expenses Total 211A, rows between Income Total 210A and the first expense, and all rows below the Expenses Total rows are not editable.

Operationally, I want to emphasize the math as it critical to this program. Referring to FIG. 7, the Current Balance 242 is the result of subtracting the Total Expenses 248 from the Total Income 247. The Income Total 235 is the sum of the previous balance and income rows 234. Any change to the Income Total 235 causes the Current Balance 242 to change appropriately. The Expense Total 237 is the sum of the expense rows 236, and a change to the Expense Total 237 causes the Current Balance 242 to change appropriately. The payee ‘Christmas Fund’ 243 is an accrual payee. A change to any value in that payee's row 244 will be duplicated in the corresponding accrual row 245 within the same period. The Accrual Balance 240 is the sum of all the accruals rows 238. The Actual Checkbook Balance 246 is the sum of the Current Balance 242 and the Accrual Balance 240.

The values within any cell located in the period columns in the Income, Expense, or Accrual rows are transactions and the program retains information regarding those transaction. In FIG. 7, the cursor is hovering above cell 233 and the status indicator is providing additional information to the user. In this case it is stating that this payment in period Mar. 10, 2006 is for Mar. 15, 2006. It is also stating that the current loan balance is $15,650.00. In FIG. 8, the cursor is hovering above cell 249 ‘My Spouse's Employer’ and the status indicator is stating that this payment in period Mar. 10, 2006 is for income payment Mar. 6, 2006. Unlike expenses, the program places all income in a period following the due date unless the due date falls on the period date. This requirement ensures the deposit is present and available; the money must be in the bank. All transactions for a given payee are located in the period columns on the same row as the payee as seen in FIG. 8, 250 & 251.

Transactions can be edited or deleted directly or with the help of the context menu 293 as seen in FIG. 40. Users can directly enter a value 292 into any valid cell to change its value. Placing a zero in a cell causes the program to delete that transaction and blanks the cell. The context menu also provides a means for deleting the transaction which zeros and blanks the cell. New transactions can easily be entered into any blank cell 294 of an existing payee as seen in FIG. 41. Transactions can also be created for existing payees who do not appear in the desired month or for new payees by selecting a cell on one of the empty income or expense rows 295, refer to FIG. 42. The period which contains the selected cell will be used as the due date of the transaction. Selecting ‘Insert Transaction’ from the context menu calls the ‘Insert Transaction’ form as displayed in FIG. 43. You can either enter a new payee, or select an existing payee from the pull-down 296. FIG. 44 shows the entry of a new payee ‘Cable Company’ with a $75.00 payment amount. Clicking ‘Enter’ loads the ‘Payee Entry’ form FIG. 45, where the description 297, amount 299, and Due Date 301 are filled in from the previous form and cell location. Expense 298 is selected based on cell location, and the Monthly radio 300 is checked by default for expenses. If this were an accrual, you should check the ‘Yes’ radio button 302. If this were a ‘Compute end date’ transaction, you should also check the ‘Yes’ radio button 303 and provide a target amount 304. Quick Transactions, referring to the context menu 290, FIG. 42 are single entry (nonrecurring) transactions. The Quick Transaction form FIG. 46 requires 3 entries description 305, amount 307, and category 308. The Income type 306 is selected based on the cell location. Clicking ‘Finished’ shows the newly created transaction 309 and payee as show in FIG. 47. Please notice that payees are automatically alphabetized 211. Since the preceding example ‘Home Maintenance’ was a single (nonrecurring) entry, it does not exist in any other month. If however you needed to do additional home maintenance and wanted to use this payee, all you need to do is place the cursor on a blank expense row in the period you want to record the transaction and select ‘Insert Transaction’ from the context menu. All you need to do is select ‘Home Maintenance’ from the pull-down menu as displayed in FIG. 48.

Referring back to FIG. 7, 243 Christmas Fund is an accrual payee. Accrued monies can be withdrawn by making an applied payment transaction. Referring to FIG. 49, an applied payment 311 removes the money from the accrual balance 312 and thusly from the main account. If you try to withdraw more money than is currently accrued, the program will issue a message indicating that it is adjusting the amount to the current balance for an ending balance of zero. If the accrual balance drops to zero, the next month will not display an accrual area as shown in FIG. 50, 215. The Actual Ending Checkbook Balance label and amount is also removed 222. An applied payment can be entered directly by placing a minus sign in front of the number, or by selecting ‘Apply Payment’ from the context menu 315 as shown in FIG. 51. FIG. 52, 216 shows the accrual area with a couple of accruals.

Once a payee is created there is often the need to modify the attributes of that payee to reflect actual changes in the user's financial situation. In anticipation of these changes, the program has provided a means of managing payees via the Edit, Insert, and Delete payee methods. These methods are most easily accessed via the context menu 317 as displayed in FIG. 53. The Edit and Delete Payees methods are accessible from the main menu under Edit as displayed in FIG. 3, 229. Referring back to FIG. 53, 317 Edit Payees and Delete Payees are only available when a payee is selected. Insert Payee is only available when an empty cell in the Transaction Descriptions column in the Income or Expense areas is selected. When editing a ‘Compute end date’ payee the program provides a warning message alerting the user that some changes could affect the entire year's worth of transactions. Referring to FIG. 54, allowable edits are description 318, category 320, amount 321, the pay-period group 322, and activity 323. The income/expense group 319, accrual group 324, compute end date group 325, and target amount 326 are un-editable and are grayed (unavailable). Changing the amount or pay-periods will cause an Effective Date form to appear where the user selects a period when the changes will become effective. All transactions starting at the effective date forward are deleted and replaced with new transactions using the new parameters. The ‘Edit Activity’ button calls the ‘Edit Activity’ form FIG. 55 where the user can make this payee inactive. The ‘Change Effective Date’ button 327 calls a form where the user selects the period when this payee will become inactive. Payee activity is primarily used in deciding which items to select in building next year's budget.

The Category Maintenance form provides a means of creating, and editing categories. The form is accessible from the View menu 230 as displayed in FIG. 4. A fully loaded form is displayed in FIG. 56. Right-clicking any category will bring up a context menu that provides two options: New, and Edit. Selecting new will allow you to create a new child category. Selecting Edit, provides a means of editing the category and brings up the ‘Category Edit’ form as displayed in FIG. 57. With this form you can rename the category 330, or simply make it inactive 331. Since categories are tied to other pieces of data, they cannot be deleted, but can be made inactive. Inactive categories can be hidden in the main form 329, FIG. 56. New categories as accessed through the context menu or the New Category button 328 call the ‘Category Entry’ from as displayed in FIG. 58. After entering the form, you should decide whether this is an income or expense category 332. Enter a category name 274, and decide if the category has a parent. If you want to select a parent, you must click the ‘Yes’ radio button 276, and select the parent 335. Clicking ‘Accept’ saves the category.

The ability to create reports is a basic requirement of any program; this program presents the user with the ability to create a varied mix of reports. The reports form can be access from the tool bar 202 as displayed in FIG. 1, or from the View menu 230 in FIG. 4. The Report Selection form is displayed in FIG. 59. The form is divided into four groups accessible through tabs 336. Each group provides different reporting parameters as detailed: Group 1 reports all Income and Expenses; Group 2 reports all Income and I Expense; Group 3 reports selected Expenses; and Group 4 reports selected Income. All groups create reports against selected periods or the year. The report period group 337, FIG. 60 provides radio buttons 338 which allow the user to select between month/quarter and yearly reporting. By default the current system month is highlighted see FIG. 59, 339. Quarters can be selected by scrolling down past December. As stated earlier, the program only creates months from the current month through the end of the year. So, only months and quarters that exist in the budget will be displayed in the list box 339, FIG. 60. FIG. 64 is a screenshot of the Income with all Expense report for April with chart labels 343. FIG. 65 is the same report without chart labels. Chart Labels are controlled be selecting either of the chart label radio buttons 340 show in FIG. 60. FIG. 66 is the Income with all Expense report for the year. Report Group 2-4 provides the ability to select categories 341 and chart styles 342 as show in FIG. 61. Group 2 allows for the selection of one category where Groups 3 & 4 allows for the selection of multiple categories. FIG. 67 is a sample report from Report Group 2 and is using the 3D Pie chart. FIG. 62 is a screenshot of Report Group 3 with multiple category selections. FIG. 68 is a sample report from Report Group 3 and it is using a 3D Line chart. FIG. 63 is a screenshot of Report Group 4 and FIG. 69 is a sample report using the Column Clustered 3D chart.

The Tools menu 231 as displayed in FIG. 5 has three menu items: Clear Recent File List, Change Initial Balance, and Create Next Year's Budget. The recent file list 228 in FIG. 2 keeps track of up to eight recently opened budgets; Clear Recent File List clears the list. The initial balance or starting balance is derived from a reconciled amount from the main account and is used to synchronize the budget with the actual account. The Change Initial Balance item provides a means of changing that amount. The current embodiment of this program is to create a budget that is contained within one calendar year. The Create Next Year's Budget menu item provides an easy method of generating a new budget based on the current year's budget. FIG. 70 is a screenshot of the first screen of the wizard. Step 2 in the process is to give the new budget a new and unique name 344 as displayed in FIG. 71. FIG. 72 is the final step to building the new budget. FIG. 74 is a screenshot of the newly created 2007 budget.

As previously stated FIG. 34, 284 is displaying a Tithe payee. Tithe payees create transactions that are 10% of the income for a given period. These transactions are updated automatically as income increases or decreases, and so there needed to be a method to allow the user to change the value and override the update. The Tithe Lock solves the problem by allowing the user to lock the transaction from automatic updates. Clicking any tithe transaction will display the ‘Edit Tithe Lock’ menu item 345 on the context menu as displayed in FIG. 75. Additionally, to prevent changing reconciled values, the program locks all tithe locks with periods earlier than the current system date 204. The icon 345 is displaying an unlocked lock in period Mar. 31, 2006 since the system date 204 is Mar. 28, 2006. The lock in FIG. 76, 347 is locked because the period is Mar. 24, 2006. Selecting ‘Edit Tithe Lock’ 347 from the context menu calls the Edit Tithe Lock form as displayed in FIG. 77. The form displays the current status of the lock 348 which can be changed as required.

A vertical Scrollbar 350 will appear as the amount of income, expenses, and accruals grow, As can be seen in FIG. 78, 349 the rows above the expense area are frozen. Expenses scroll up and disappear at the frozen row above the first expense row. A horizontal scrollbar 350A appears when the window size shrinks to hide columns, see FIG. 79. Horizontal scroll arrows 352 are automatically added to the tab bar 351 to provide a means to access hidden tabs.

Referring to FIG. 80, the status indicator 203 provides helpful information regarding the actual location of the cursor 362 which is on an empty expense row on period Mar. 3, 2006. Knowing exactly which row and period the cursor is on is helpful as that information is loaded into subsequent forms. In FIG. 81, the status indicator 203 is stating the cursor 354 is on the ‘ABC (Auto Ins)’ row in period Mar. 17, 2006. As previously stated, accrual balances increase, whereas compute end date transactions decrease. Referring to FIG. 82, the cursor 356 is hovering above the accrual ‘Christmas Fund’ in period Mar. 24, 2006 with a balance of $180.00. Please note that the Accrual Balance 355 reflects the $180.00 balance. Lastly, the cursor 357 in FIG. 83 is hovering above the compute end date transaction ‘Nissan’ in period Mar. 15, 2006 with a balance of $15,650.00.

Referring to FIG. 84, payee Special Payoff 363 was created in period Jan. 13, 2006 with a transaction amount of $1,500.00. This caused the current balance to go negative 364 in period Jan. 27, 2006. As can be seen, the program highlights the negative cell in red. Every succeeding period that is negative will also be highlighted in red. This provides a visual indicator to the user that the situation must be corrected.

### Description—Alternative Embodiment—FIG. 85

Another embodiment of this invention is integration with an external checkbook register application, specifically the data. This can be seen in FIG. 85 which shows both applications. This program extracts data from the checkbook register 365 and updates payees, categories, and transactions.

### Operation—Alternative Embodiment—FIG. 85

This embodiment uses an additional feature whereby it is designed to extract payee, category, and transaction information for an external checkbook register program, see FIG. 85, 365. The program will interrogate the checkbook register's stored data file for updates, and will create payees, categories, and transactions as required. Imported transactions will be locked to maintain synchronized integrity.

### Conclusion, Ramifications and Scope

This invention—application was designed to create and manage Living Budgets. You might say, “What is the difference between a budget and a Living Budget?” The following is the definition of a budget:
1a: a statement of the financial position of an administration for a definite period of time based on estimates of expenditures during the period and proposals for financing them 1b: a plan for the coordination of resources and expenditures 1c: the amount of money that is available for, required for, or assigned to a particular purpose
2a: an itemized summary of estimated or intended expenditures for a given period along with proposals for financing them: submitted the annual budget to Congress. 2b: a systematic plan for the expenditure of a usually fixed resource, such as money or time, during a given period: A new car will not be part of our budget this year. 2c: the total sum of money allocated for a particular purpose or period of time: a project with an annual budget of five million dollars.

I define a Living Budget as the evolving statement of financial position laid out in terms where one can easily manipulate its various components and see the results across all periods within its scope, which is typically a year; differs from a budget in that proposed solutions are easily discernible by virtue of the layout; optimal results are achieved with consistent, habitual use.

Accordingly, the reader can see that the presented methodology for the management of finances and in particular personal finances provides the user with the following benefits:
Wizards facilitate the easy creation of budgets which can start this year or next. Additionally, a Next Year's wizard is used to carry the existing budget into the next year.
A well organized grid layout which holds a months worth of financial activities which provides easy access to any month within the year, and provides full real-life financial visibility.
Provides a means of easily creating one-time or recurring payees.
Provides a means of tracking loan balances and terminating payments once the balances have been satisfied. Increasing or decreasing a transaction amounts will decrease or increase the payoff period.
Provides a means of easily creating accruals that are typically used by individuals for savings type items. Reliving the accrual is fast and easy and can occur at any time.
Provides a means to easily create tithe payees. Tithe payees are payees whose payment amounts are equal to 10% of the total income for a given period. Tithe payees are normally used for charitable reasons, but can also be used as a way for individuals to save; they can tithe to their savings account.
Provides a means of easily creating, editing, and deleting transactions. Transactions can even be created in months where the payee is not visible.
Provides a means of easily seeing where the budget has gone negative.
Provides a means of creating many what-if scenarios by virtue of its ability to easily create and delete payees and transactions. These scenarios help the users determine the best payment options for their situation.

Although the description above contains many specifications, these should not be construed as limiting the scope of the invention but as merely providing illustrations of some of the presently preferred embodiments of this invention. For example, this application could easily be incorporated into a check register application, providing a different face to showing the net results of expenditures

The scope of the invention should be determined by the appended claims and their legal equivalents, rather than by the examples given.

I claim:

1. A method for creating and managing an electronic, evolving statement of financial position on a computer system having a display device, an entry device, and a pointing device, comprising:
(a) providing a means of storing a plurality of payees,
(b) providing a means of storing a plurality of pay-periods,
(c) providing a means of storing a plurality of transactions,
(d) providing a means of displaying a workspace on said display device, where said workspace is divided into a plurality of rows and a plurality of columns, the number of said rows is derived from the number of said payees plus additional said rows for totals with blank said rows for visual clarity, the number of said columns is at a minimum one to display a description of said payees, and a variable number of said columns which represent said pay-periods that are based on the individual's financial situation, said payees of the income type are separated from said payees of the expense type for clarity,
(e) using said entry device, the user repetitively enters all said payees which comprise their income and debts, said payees individually consists of a payee description, a payee income type, a payee category, a payee amount, a payee pay-period, and a payee due date,
(f) completing the entry of all said payees, a plurality of said columns of the said pay-period type are displayed on said workspace based on the individual's financial situation, a plurality of said transactions are created for each of the said payees based on said payee pay-period and said payee due date, said transactions are located on said row where its owner, the said payees resides, in the said pay-period,
(g) providing a means of summing all said payees of the income type for a given said pay-period with a previous balance in the same said pay-period creating a total income for that same said pay-period,
(h) providing a means of summing all said payees of the expense type for a given said pay-period creating a expense total for that same said pay-period,
(i) providing a means for deducting said expense total from said income total for a given said pay-period to produce a current balance for that same said pay-period,
(j) providing a means for equating said previous balance of a given said pay-period to the said current balance from the previous said pay-period,
(k) providing a means where any said transaction can be edited, or deleted,
(l) providing a means where any of the said payees can be edited, or deleted,
whereby any changes in said transactions values or any change to said payee amount, or said payee pay-period, causes an immediate change in the value of said current balance which provides immediate visual feedback to the user regarding the evolving state of their financial position, additionally, the ability to easily edit or change said payee pay-period, or said transactions creates the ability to apply many what-if scenarios to their current financial situation and immediately see the results.

2. The method of claim 1 where said payees have the additional attribute of a payee ced and a payee target amount,
(a) providing a means where the number of created said transactions for said payee ced are based on said payee amount, said payee pay-period, and said payee target amount, where transactions will cease once said payee target amount is reached,
whereby the user will benefit from seeing a completed updated budget, one in which only lists active said transactions, where the program stops creating said payee ced said transactions once the balance reaches zero.

3. The method of claim 2 where a means has been provided to change the number of said transactions for said payee ced, upon the edit, deletion or insertion of said transaction or as a result of the change of said payee pay-period, or said payee amount, whereby the user will benefit from seeing an updated budget, one in which changes to said payee ced said transactions, increases or decreases the number of said transactions thereby providing updated balances.

4. The method of claim 2 where said payees have the additional attribute of a payee accrual,
(a) providing a means displaying a accrual area on said workspace whenever said payees of the said payee accrual type exist within the displayed period, said accrual area consists of additional said rows located below said current balance row, since said payee accrual is also an expense type, said payee accrual is displayed with the other expense type said payees,
(b) providing a means of displaying an accrual row located in said accrual area for said payee accrual, said transactions mirror transactions by the same said payee accrual located in the expense area, in the same said pay-period,
(c) providing a means of summing all said payees of the said payee accrual within the accrual area for a given said pay-period creating a total accruals,
(d) providing a means of displaying within said workspace, a carryover within the said accrual area,
(e) providing a means of summing the said total accruals and said carryover within a given said pay-period to create a accrual balance for that same said pay-period,
(f) providing a means for equating said carryover of a given said pay-period to the said accrual balance from the previous said pay-period,
(g) providing a means of displaying within said workspace, a actual checkbook balance that is the result of adding the said current balance to the said accrual balance for a given pay-period,
whereby the user will benefit from the ability to easily and gradually save up for items which lessons that expenditures impact to the users overall financial position.

5. The method of claim 1 where said workspace is separated into 12 easily accessible workspaces which are accessed through tabs which represent the months of the year, whereby the user benefits from seeing a cleaner workspace that not only provides the required monthly separation but also provides an easy and quick means of viewing the update changes in any month.

6. The method of claim 1 wherein a means is provided so that when said current balance is negative, its cell color changes to red,
whereby the user benefits by being able to easily see where their finances have gone out of balance.

7. The method of claim 1 where said payees and said transactions are updated from an external check register application which has a plurality of external payees and a plurality of external transactions comprising:
(a) providing a means where said payees and said transactions are updated by said external payees and by said external transactions,
whereby the user can more easily manage their ongoing financial affairs.
